(19) United States
(12) Patent Application Publication
(10) Pub. No.: US 2023/0132198 A1
(43) Pub. Date: Apr. 27, 2023

(54) FILAMENT ARTICLE CONTAINING EPOXY-AMINE CURABLE COMPOSITION

(71) Applicant: 3M INNOVATIVE PROPERTIES COMPANY, St. Paul, MN (US)

(72) Inventors: Gregory P. Sorenson, Maplewood, MN (US); Ross E. Behling, Woodbury, MN (US); John Christopher Thomas, St. Paul, MN (US)

(21) Appl. No.: 17/904,880

(22) PCT Filed: Mar. 16, 2021
(86) PCT No.: PCT/IB2021/052192

§ 371 Date: Aug. 24, 2022

Related U.S. Application Data
(60) Provisional application No. 63/002,481, filed on Mar. 31, 2020.

(51) Int. Cl. C08G 59/50; D01D 5/34; D01F 8/12; B29C 64/118; B33Y 10/00; B33Y 70/00

(52) U.S. Cl. CPC C08G 59/50; D01D 5/34; D01F 8/12; B29C 64/118; B33Y 10/00; B33Y 70/00; B29K 2063/00

(57) ABSTRACT

A filament article containing a curable composition is provided. The filament article has a first part containing an epoxy resin and a second part containing a polyamine having at least two secondary or primary amino groups. The first part is surrounded by a sheath and a second part surrounded by a sheath. Either 1) the first part surrounded by the sheath and the second part surrounded by the sheath are each a separate filament or 2) the first part surrounded by the sheath and the second part surrounded by the sheath combine to form a composite filament. The curable filament article can be used to form a cured composition having structural bonding performance.

### BACKGROUND

The use of fused filament fabrication (FFF) to produce three-dimensional articles has been known for a relatively long time, and these processes are generally known as methods of so-called 3D printing (or additive manufacturing). In FFF, a plastic filament is melted in a moving printhead to form a printed article in a layer-by-layer, additive manner. The filaments are often composed of polylactic acid, nylon, polyethylene terephthalate (typically glycol-modified), or acrylonitrile butadiene styrene.

Various two-part curable compositions containing an epoxy resin and polyamines are known and have been used for bonding various surfaces together. For example, the curable compositions can be used to form structural bonds between surfaces.

### SUMMARY

A filament article containing a curable composition is provided. The filament article has a first part containing an epoxy resin and a second part containing a polyamine having at least two secondary or primary amino groups. The first part is surrounded by a sheath and a second part surrounded by a sheath. Either 1) the first part surrounded by the sheath and the second part surrounded by the sheath are each a separate filament or 2) the first part surrounded by the sheath and the second part surrounded by the sheath combine to form a composite filament. The curable filament article can be used to form a cured composition having structural bonding performance.

In a first aspect, a filament article containing a curable composition is provided. The curable composition contains a first part and a second part that is separated from the first part. The first part contains an epoxy resin while the second part contains a polyamine having at least two primary or secondary amino groups. The filament article further includes a sheath that contains a thermoplastic resin that is non-tacky and that surrounds each of the first part and the second part. Either 1) the first part surrounded by the sheath and the second part surrounded by the sheath are each a separate filament or 2) the first part surrounded by the sheath and the second part surrounded by the sheath combine to form a composite filament.

In a second aspect, a method of making a filament article containing a curable composition is provided. The method includes forming (or providing) a first part that contains an epoxy resin and forming (or providing) a second part that is separated from the first part and that contains a polyamine having at least two primary or secondary amino groups. The method further includes surrounding each of the first part and the second part with a sheath that includes a thermoplastic resin that is non-tacky. Either 1) the first part surrounded by the sheath and the second part surrounded by the sheath are each a separate filament or 2) the first part surrounded by the sheath and the second part surrounded by the sheath combine to form a composite filament.

In a third aspect, a method of printing and bonding is provided. The method includes providing a filament article containing a curable composition as described above in the first aspect. The method further includes melting and blending the filament article to form a molten composition. The method still further includes dispensing the molten composition through a nozzle onto at least a first portion of a first substrate. The method yet further includes positioning either a second substrate or a second portion of the first substrate in contact with the molten composition and forming a structural adhesive bond between at least the first portion of the first substrate and either the second substrate or the second portion of the first substrate.

### BRIEF DESCRIPTION OF THE DRAWINGS

FIG. 1 is a cross-sectional view of an example filament article where a first part and a second part are each surrounded by a sheath to form two separate filaments.

FIG. 2 is a cross-sectional view of another example filament article where a first part surrounded by a sheath and a second part surrounded by a sheath combine to form a composite filament.

FIG. 3 is a cross-sectional view of another example filament article where a first part surrounded by a sheath and a second part surrounded by a sheath combine to form a composite filament.

FIG. 4 is a cross-sectional view of yet another example filament article where a first part surrounded by a sheath and a second part surrounded by a sheath combine to form a composite filament.

### DETAILED DESCRIPTION

Structural adhesives have been used for bonding together two surfaces such as the outer surfaces of two substrates or different locations (portions) of the same substrate. Curable structural adhesives (i.e., curable compositions) are often available as either a one-part or two-part composition. One-part compositions typically include all the components of the curable composition in a single mixture. The components are selected so that curing does not occur until the curable composition is exposed to heat or actinic radiation. Two-part compositions include a first part and a second part that are usually reactive when mixed together.

Two-part compositions are often delivered using either a two-cartridge metering system or a precision metering system and mixing of two independent feed sources. The equipment needed for precise mixing and metering is often expensive and covers a large footprint along a manufacturing line. Two-cartridge metering systems offer the convenience of a pre-determined mix ratio of reactant parts but tend to generate a great deal of waste and may necessitate an undesirable amount of down time to switch cartridges once emptied.

To address these needs, a filament article is provided that contains a curable composition that is divided into two separate parts. The curable composition has a first part and a second part with each part being surrounded by a sheath. Either 1) the first part surrounded by the sheath and the second part surrounded by the sheath are each a separate filament or 2) the first part surrounded by the sheath and the second part surrounded by the sheath are combined to form a composite filament. The filament article can be heated and mixed to form a molten composition that can be dispensed onto a substrate and cured. The resulting cured composition can typically function as a structural bonding adhesive between two surfaces.

The terms “a”, “an”, and “the” are used interchangeably with “at least one” to mean one or more of the elements being described. The phrases “at least one of” and “comprises at least one of” followed by a list refers to any one of the items in the list and any combination of two or more items in the list.

The term “and/or” means either or both. For example, the expression X and/or Y means X, Y, or a combination thereof (both X and Y).

The term “curable” refers to a composition or component that can be cured. The terms “cured” and “cure” refer to joining polymer chains together by covalent chemical bonds, usually via crosslinking molecules or groups, to form a polymeric network. A cured polymeric network is generally characterized by insolubility, but it may be swellable in the presence of an appropriate solvent.

The term “curable component(s)” as used herein refers to the curable composition minus any inorganic filler that may be present. As used herein, the curable components include, but are not limited to, the epoxy resin and the polyamine.

The term “curable composition” refers to a total reaction mixture that is subjected to curing. The curable composition includes the curable components and any optional inorganic fillers. The curable composition in the filament articles is usually all the materials used to prepare the filament articles except the sheath material.

As used herein, the terms “curable structural adhesives”, “curable structural adhesive compositions”, “curable composition”, and the like are used interchangeably. Likewise, the terms “cured structural adhesive”, “cured structural adhesive compositions”, “cured composition”, and the like are used interchangeably.

The term “thermoplastic” refers to a polymeric material that flows when heated sufficiently above its glass transition temperature and become solid when cooled.

As used herein, “filament” includes reactive components such as those in the first part or the second part that are surrounded by a sheath material. While the filament is typically concentric, the cross-sectional shape of the filament can be any desired cross-sectional shape such as a circle, oval, square, rectangle, triangle, or the like. The ends of the core may or may not be surrounded by the sheath. The filament typically has an aspect ratio of length to longest cross-sectional distance equal to at least 50:1.

The sheath surrounds the core in the core-sheath filament. In this context, “surround” (or similar words such as “surrounding”) means that the sheath composition covers the entire perimeter (i.e., the cross-sectional perimeter) of the core for a major portion (e.g., at least 80 percent or more, at least 85 percent or more, at least 90 percent or more, or at least 95 percent or more) of the length (the long axis direction) of the filament. Surrounding is typically meant to imply that all but perhaps the very ends of the filament have the core, which contains one or more components of the curable composition, covered completely by the sheath. Sealing the ends of the filament can often extend the shelf life and/or stability of the curable composition.

The sheath separates the first part from the second. The terms “separated” and “separate” mean that the two parts are not in physical contact with each other so that the two parts are not able to react with each other (i.e., the sheath prevents the premature curing of the curable composition).

The term “non-tacky” refers to a material that passes a “Self-Adhesion Test”, in which the force required to peel the material apart from itself is at or less than a predetermined maximum threshold amount, without fracturing the material. The Self-Adhesion Test is described below and is typically performed on a sample of the sheath material to determine whether the sheath is non-tacky.

The term “melt flow index” or “MFI” refers to the amount of polymer that can be pushed through a die at a specified temperature using a specified weight. Melt flow index can be determined using ASTM D1238-13 at 190° C. and with a load (weight) of 2.16 kg. Some of the reported values for the melt flow index are available from vendors of the sheath material and others were measured by the applicants using Procedure A of the ASTM method. The vendor data was reported as having been determined using the same ASTM method as well as the same temperature and load.

The term “semi-solid” refers to a substance that is between a liquid and a solid and that is resistant to flow at room temperature (e.g., in a range of 20° C. to 25° C.) but that can flow at elevated temperatures. The semi-solid often is a self-supporting material that can be formed into a shaped mass. The semi-solid is often a waxy composition or viscoelastic. In some embodiments, the first part and/or the second part have a shear elastic modulus (G′) from 10⁴-10⁶ Pascals (Pa) at 25° C. when measured at 1 Hertz and 1 percent strain. In some embodiments, the first part, the second part, or both have a complex viscosity (η*) from 10³-2.5×10⁵ Pascal·seconds (Pa·s) at 25° C. when measured at 1 Hertz and 1 percent strain.

The term “macroscopically stable” means that there is no change to the average three-dimensional distribution of components with time. The term “macroscopic phase separation” refers to spontaneous partitioning of components of a composition into distinct three-dimensional regions with at least one dimension having an average length of 1 micrometer. Often macroscopic phase separation is visible to the naked eye.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used herein, any statement of a range includes the endpoint of the range and all suitable values within the range (e.g., 1 to 5 includes 1, 1.5, 2, 2.75, 3, 3.80, 4, 5, etc.).

### Filament Articles and Methods of Making

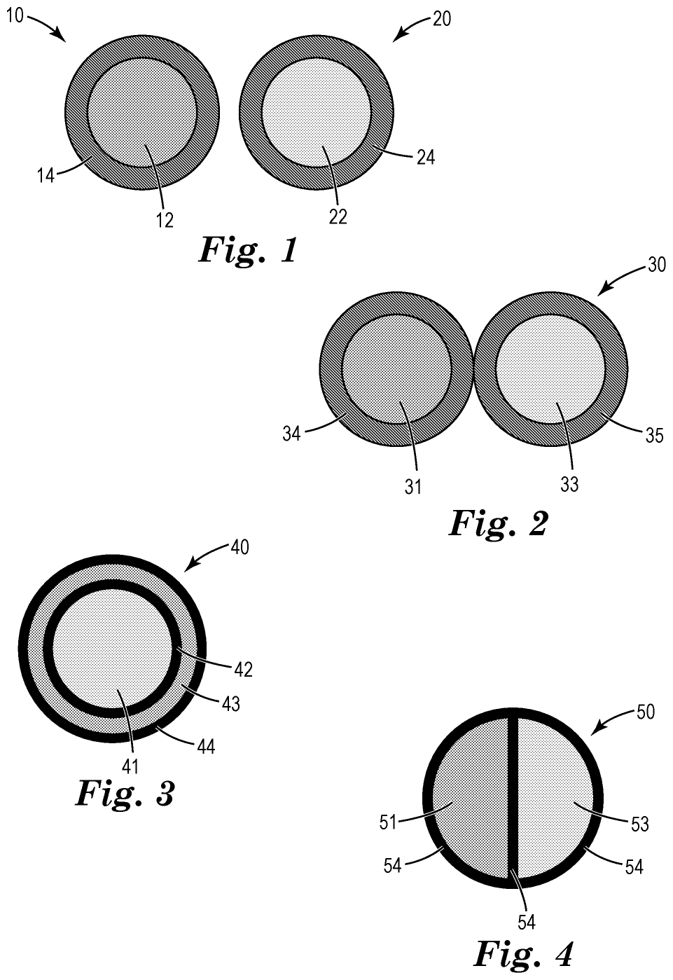

FIG. 1 is a cross-section view of an example filament article where each part is surrounded by a sheath to form two separate filaments. The first filament 10 contains a first part 12 surrounded by a sheath 14 and the second filament 20 containing the second part 22 surrounded by a sheath 24. The sheath 14 and 24 can be formed of the same or different non-tacky thermoplastic resin. Together, the first filament 10 and the second filament 20 contain the curable composition.

FIG. 2 is a cross-sectional view of another example filament article 30 where the first part 31 surrounded by a first sheath 34 and the second part 33 surrounded by a second sheath 35 combine to form a composite filament that contains the curable composition. The first sheath 34 and the second sheath 35 can be formed of the same or different non-tacky thermoplastic resin.

FIG. 3 is a cross-sectional view of another example filament article 40 where the first part 41 is surrounded by the first sheath 42 and where the second part 43 is positioned between the first sheath 42 and a second sheath 44. The first sheath 42 separates the first part 41 from the second part 43 while the second sheath 44 constrains the second part 43. The first sheath 42 and the second sheath 44 can be formed of the same or different non-tacky thermoplastic resin. This filament article 40 is a composite filament that contains the curable composition.

FIG. 4 is a cross-sectional view of yet another example filament article 50 that contains a composite filament. The composite filament contains a first part 51 and a second part 53 that are separated by a sheath 54. The sheath surrounds both the first part 51 and the second part 53 with the first part 51 being separated from the second part 53.

The entire curable composition is included in the filament article. The epoxy resin in the first part of the curable composition is separated from the polyamine in the second part of the curable composition. The first part and the second part are separated in the filament article to prevent premature curing of the curable composition prior to deposition onto a substrate and/or before forming a structural bond between two substrates or different regions of a single substrate.

A sheath surrounds each part and constrains each part so that the overall dimensions of the filament article remain relatively constant. That is, the sheath material can be selected to provide reinforcement to the filament article during shipping, handling, and dispensing. The sheath constrains the reactants in each part and prevents their premature mixing even when the filament article is wound into a roll.

The filament articles include either separate filaments for the first part and the second part or a composite filament that contains both the first and second parts. In both types of filament articles, the first part is separated from the second part so that no premature curing of the curable composition occurs. Curing does not occur until a molten composition is formed from the filament article.

Each filament and/or the composite filament can have any desired longest cross-sectional distance (e.g., diameter). As used herein, the “longest cross-sectional distance” refers to the greatest length of a chord that can be drawn through the cross-section of a filament and/or composite filament at any given location along its axis. For a filament and/or composite filament having a circular cross-section, the longest cross-sectional distance corresponds to the diameter. If the filament article is to be used in applications where precise deposition of the curable composition is needed or advantageous, the longest cross-sectional distance is often selected to be in a range of 1 to 30 millimeters (mm). The longest cross-sectional distance can be at least 1 mm, at least 2 mm, at least 3 mm, at least 5 mm, at least 7 mm, at least 10 mm and up to 30 mm or even greater, up to 25 mm, up to 20 mm, up to 15 mm, up to 12 mm, or up to 10 mm. Depending on the application or use, filaments and/or composite filaments having a relatively consistent longest cross-sectional distance may be advantageous.

Often, 0.1 to 25 percent of the longest cross-sectional distance (e.g., diameter) of the filament and/or composite filament is contributed by the sheath and 75 to 99.9 percent of the longest cross-sectional distance (e.g., diameter) of the first part, the second part, or both. For example, up to 25 percent, up to 20 percent, up to 15 percent, up to 10 percent, up to 8 percent, up to 6 percent, or up to 5 percent and at least 0.1 percent, at least 0.5 percent, at least 1 percent, at least 2 percent, or at least 5 percent of the longest cross-sectional distance of the filament and/or composite filament can be contributed by the sheath with the remainder being contributed by the first part and/or the second part. In some examples, the sheath contributes 0.5 to 20 percent, 0.5 to 15 percent, 0.5 to 10 percent, or 1 to 10 percent of the longest cross-sectional distance of the filament and/or composite filament. The sheath extends completely around the perimeter (e.g., circumference, in the case of a circular cross-section) of the filament and/or composite filament to prevent premature curing.

Often, each filament and/or composite filament of the filament article has an aspect ratio of length to longest cross-sectional distance of 50:1 or greater, 100:1 or greater, 200:1 or greater, or 250:1 or greater. Filaments and/or composite filaments having a length of at least 20 feet (6 meters) can be especially useful for deposition onto a substrate. Depending on the application or use of the filament article, having a relatively consistent longest cross-sectional distance (e.g., diameter) over its length can be desirable. For instance, an operator might calculate the amount of material being melted and dispensed based on the expected mass of the filament or composite filament per predetermined length; but if the mass per length varies widely, the amount of material dispensed may not match the calculated amount. In some embodiments, the filament and/or composite filament has a maximum variation of longest cross-sectional distance (e.g., diameter) of 20 percent over a length of 50 centimeters (cm), or even a maximum variation in longest cross-sectional distance (e.g., diameter) of 15 percent over a length of 50 cm.

The filament articles can be used to deposit the curable adhesive composition in any location or amount necessary to bond two substrates or different regions of the same substrate together. If desired, additional heat can be applied to accelerate the curing reaction.

The filament article desirably has strength consistent with being handled without fracturing or tearing of the sheath. The structural integrity needed for the filament article depends on the specific application or use. Preferably, the filament article has strength consistent with the requirements and parameters of one or more additive manufacturing devices (e.g., 3D printing systems). One additive manufacturing apparatus, however, could subject the filament article to a greater force when feeding the filament article to a deposition nozzle than a different apparatus. As formed, the filament article desirably also has modulus and yield stress consistent with being handled without excessive or unintentional stretching.

Advantageously, the elongation at break of the sheath material of the filament article is 50 percent or greater, 60 percent or greater, 80 percent or greater, 100 percent or greater, 250 percent or greater, 400 percent or greater, 750 percent or greater, 1000 percent or greater, 1400 percent or greater, or 1750 percent or greater and 2000 percent or less, 1500 percent or less, 900 percent or less, 500 percent or less, or 200 percent or less. Stated another way, the elongation at break of the sheath material of the filament article can range from 50 percent to 2000 percent. In some embodiments, the elongation at break is at least 60 percent, at least 80 percent, or at least 100 percent. Elongation at break can be measured, for example, by the methods outlined in ASTM D638-14, using test specimen Type IV.

The filament articles can be used for printing or dispensing a curable composition using fused filament fabrication (FFF). The material properties needed for FFF dispensing typically are significantly different than those required for hotmelt dispensing of a curable structural adhesive composition. For instance, in the case of traditional hotmelt dispensing, the curable composition is melted into a liquid inside a tank and pumped through a hose and nozzle. Thus, traditional hotmelt dispensing requires a low-melt viscosity curable composition, which is often quantified as a high melt flow index curable composition. If the viscosity is too high (or the melt flow index (MFI) is too low), the hotmelt curable composition cannot be effectively transported from the tank containing the fluid curable composition to the nozzle where is it dispensed. In contrast, FFF includes melting a filament within the nozzle at the point of dispensing and is not limited to low melt viscosity curable compositions (high melt flow curable compositions) that can be easily pumped. In fact, a high melt viscosity curable composition (a low melt flow index curable composition) can advantageously provide geometric stability to the curable composition after dispensing, which allows for precise and controlled placement of the curable composition on the substrate of interest. The curable composition typically does not spread excessively after being deposited (printed).

In addition, suitable filament articles for FFF typically require at least a certain minimum tensile strength so that large spools of filament can be continuously fed to the nozzle without breaking. The filament articles are usually spooled into level wound rolls. If the filament articles are spooled into level wound rolls, the portion in the center of the rolls can be subjected to high compressive forces. Preferably, the filament articles are resistant to permanent cross-sectional deformation (i.e., compression set) and self-adhesion (i.e., blocking during storage).

The curable composition is divided into two separate parts. The first part includes the epoxy resin and the second part includes the polyamine having at least two amino groups selected from primary amino groups or secondary amino groups. Typically, the first part and the second part are each prepared to be a semi-solid. Thus, each part is often a mixture of various components to provide the desired viscosity. In some embodiments, the first part and/or the second part is tacky to the touch.

Additional optional components can be included in the first part, the second part, or both parts. Any optional components added to the first part or the second part are typically selected so that no reaction occurs between the components in that part. For example, an optional accelerator such as a Lewis acid can be included in the second part but not the first part. Optional components such as film-forming resins, toughening agents, fillers, thermal stabilizers, antioxidants, and the like can be added to either the first part or the second part providing that these components do not react with the part. Each of these components are described further below.

### Curable Composition

### Epoxy Resins in the First Part

The first part of the curable composition contains an epoxy resin. The epoxy resin has at least one epoxy functional group (i.e., oxirane group) per molecule. As used herein, the term oxirane group refers to the following divalent group.

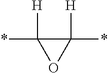 [SMILES: *C1OC1*]

The asterisks denote a site of attachment of the oxirane group to another group. If the oxirane group is at the terminal position of the epoxy resin, the oxirane group is typically bonded to a hydrogen atom.

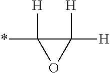 [SMILES: *C1CO1]

This terminal oxirane group is often (and preferably) part of a glycidyl group.

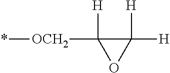

The epoxy resin often has at least one oxirane group per molecule and often has at least two oxirane groups per molecule. For example, the epoxy resin can have 1 to 10, 2 to 10, 2 to 6, 2 to 4, or 2 oxirane groups per molecule. The oxirane groups are usually part of a glycidyl group.

Epoxy resins can be either a single material or a mixture of different materials selected to provide the desired viscosity characteristics before curing and to provide the desired mechanical properties after curing. If the epoxy resin is a mixture of materials, at least one of the epoxy resins in the mixture is typically selected to have at least two oxirane groups per molecule. For example, a first epoxy resin in the mixture can have two to four oxirane groups and a second epoxy resin in the mixture can have one to four oxirane groups. In some of these examples, the first epoxy resin is a first glycidyl ether with two to four glycidyl groups and the second epoxy resin is a second glycidyl ether with one to four glycidyl groups. In another example, a first epoxy resin in the mixture is a liquid while a second epoxy resin is a solid such as a glassy or brittle solid that is miscible with the first epoxy resin.

The portion of the epoxy resin molecule that is not an oxirane group (i.e., the epoxy resin molecule minus the oxirane groups) can be aromatic, aliphatic or a combination thereof and can be linear, branched, cyclic, or a combination thereof. The aromatic and aliphatic portions of the epoxy resin can include heteroatoms or other groups that are not reactive with the oxirane groups. That is, the epoxy resin can include halo groups, oxy groups such as in an ether linkage group, carbonyl groups, carbonyloxy groups, and the like. The epoxy resin can also be a silicone-based material such as a polydiorganosiloxane-based material.

In most embodiments, the epoxy resin includes a glycidyl ether. Exemplary glycidyl ethers can be of Formula (I).

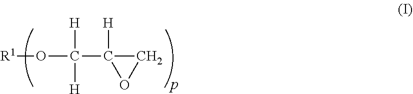

In Formula (I), group R¹ is a p-valent group that is aromatic, aliphatic, or a combination thereof. Group R¹ can be linear, branched, cyclic, or a combination thereof. Group R¹ can optionally include halo groups, oxy groups, carbonyl groups, carbonyloxy groups, and the like. Although the variable p can be any suitable integer greater than or equal to 1, p is often an integer in the range of 2 to 6 or 2 to 4. In many embodiments, p is equal to 2.

In some exemplary epoxy resins of Formula (I), the variable p is equal to 2 (i.e., the epoxy resin is a diglycidyl ether) and R¹ includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of an arene compound), or mixtures thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms. The heteroatoms in the heteroalkylene are often oxy groups. Suitable arylene groups often have 6 to 18 carbon atoms, 6 to 12 carbon atoms, or 6 to 10 carbon atoms. For example, the arylene can be phenylene. Group R¹ can further optionally include halo groups, oxy groups, carbonyl groups, carbonyloxy groups, and the like.

Some epoxy resins of Formula (I) are diglycidyl ethers where R¹ includes (a) an arylene group or (b) an arylene group in combination with an alkylene, heteroalkylene, or both. Group R¹ can further include optional groups such as halo groups, oxy groups, carbonyl groups, carbonyloxy groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, and p,p′-dihydroxybenzophenone. Still other examples include the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Some commercially available diglycidyl ether epoxy resins of Formula (I) are derived from bisphenol A (i.e., bisphenol A is 4,4′-dihydroxydiphenylmethane). Examples include, but are not limited to, those available under the trade designation EPON (e.g., EPON 828, EPON 872, EPON 1001F, EPON 1004, and EPON 2004) from Hexion Specialty Chemicals, Inc. in Houston, Tex., those available under the trade designation DER (e.g., DER 331, DER 332, and DER 336) from Dow Chemical Co. in Midland, Mich., and those available under the trade designation EPICLON (e.g., EPICLON 850) from Dainippon Ink and Chemicals, Inc. in Chiba, Japan. Other commercially available diglycidyl ether epoxy resins are derived from bisphenol F (i.e., bisphenol F is 2,2′-dihydroxydiphenylmethane). Examples include, but are not limited to, those available under the trade designation DER (e.g., DER 334) from Dow Chemical Co. and those available under the trade designation EPICLON (e.g., EPICLON 830) from Dainippon Ink and Chemicals, Inc.

Other epoxy resins of Formula (I) are diglycidyl ethers of a poly(alkylene oxide) diol. These epoxy resins can be referred to as diglycidyl ethers of a poly(alkylene glycol) diol. The variable p is equal to 2 and R⁴ is a heteroalkylene having oxygen heteroatoms. The poly(alkylene glycol) can be copolymer or homopolymer. Examples include, but are not limited to, diglycidyl esters of poly(ethylene oxide) diol, diglycidyl esters of poly(propylene oxide) diol, and diglycidyl esters of poly(tetramethylene oxide) diol. Epoxy resins of this type are commercially available from Polysciences, Inc. (Warrington, Pa., USA) such as those derived from a poly(ethylene oxide) diol or from a poly(propylene oxide) diol having a weight average molecular weight of about 400 Daltons, about 600 Daltons, or about 1000 Daltons.

Still other epoxy resins of Formula (I) are diglycidyl ethers of an alkane diol (R¹ is an alkylene and the variable p is equal to 2). Examples include a diglycidyl ether of 1,4-dimethanol cyclohexyl, diglycidyl ether of 1,4-butanediol, and diglycidyl ethers of the cycloaliphatic diol formed from a hydrogenated bisphenol A such as those commercially available under the trade designation EPONEX 1510 from Hexion Specialty Chemicals, Inc. (Houston, Tex., USA).

Yet other epoxy resins include silicone resins with at least two glycidyl groups and flame retardant epoxy resins with at least two glycidyl groups (e.g., a brominated bisphenol-type epoxy resin having with at least two glycidyl groups such as that commercially available from Dow Chemical Co. in (Midland, Mich., USA) under the trade designation DER 580).

The epoxy resin is often a mixture of materials. For example, the epoxy resins can be selected to be a mixture that provides the desired viscosity or flow characteristics prior to curing. The mixture can include at least one first epoxy resin that is referred to as a reactive diluent that has a lower viscosity and at least one second epoxy resin that has a higher viscosity. The reactive diluent tends to lower the viscosity of the epoxy resin mixture and often has either a branched backbone that is saturated or a cyclic backbone that is saturated or unsaturated. Examples include, but are not limited to, the diglycidyl ether of resorcinol, the diglycidyl ether of cyclohexane dimethanol, the diglycidyl ether of neopentyl glycol, and the triglycidyl ether of trimethylolpropane. Diglycidyl ethers of cyclohexane dimethanol are commercially available under the trade designation HELOXY MODIFIER 107 from Hexion Specialty Chemicals (Columbus, Ohio, USA) and under the trade designation EPODIL 757 from Evonik Corporation (Essen, North Rhine-Westphalia, Germany). Other reactive diluents have only one functional group (i.e., oxirane group) such as various monoglycidyl ethers. Some exemplary monoglycidyl ethers include, but are not limited to, alkyl glycidyl ethers with an alkyl group having 1 to 20 carbon atoms, 1 to 12 carbon atoms, 1 to 8 carbon atoms, or 1 to 4 carbon atoms. Some exemplary monoglycidyl ethers are commercially available under the trade designation EPODIL from Evonik Corporation such as EPODIL 746 (2-ethylhexyl glycidyl ether) and EPODIL 748 (aliphatic glycidyl ether).

In some instances, the viscosity and molecular weight of an epoxy resin can be adjusted by formation of an adduct by reacting a diglycidyl ether with a diamine such that the ratio of the moles of diglycidyl ether to moles of diamine are close to 2:1.

The one or more epoxy resins in the first part is often in a range of 50 to 750 grams/equivalent. The equivalent weight of the epoxy resin refers to the weight of resin in grams that contains one equivalent of epoxy. The equivalent weight is often no greater than 750 grams/equivalent, no greater than 700 grams/equivalent, no greater than 650 grams/equivalent, no greater than 600 grams/equivalent, no greater than 550 grams/equivalent, no greater than 500 grams/equivalent, no greater than 450 grams/equivalent, no greater than 400 grams/equivalent, no greater than 350 grams/equivalent, no greater than 300 grams/equivalent, or no great than 250 grams/equivalent and is often at least 50 grams/equivalent, at least 75 grams/equivalent, at least 100 grams/equivalent, at least 125 grams/equivalent, or at least 150 grams/equivalent. In some embodiments, the equivalent weight is often in a range of 50 to 750 grams/equivalent, 50 to 500 grams/equivalent, 100 to 500 grams/equivalent, 100 to 300 grams/equivalent, or 150 to 250 grams/equivalent.

In many embodiments, 100 weight percent of the epoxy resin is of Formula (I). In other embodiments, at least 95 weight percent, at least 90 weight percent, at least 85 weight percent, at least 80 weight percent, at least 75 weight percent, or at least 70 weight percent of the epoxy resin is of Formula (I).

In many embodiment, 100 weight percent of the epoxy resin is a diglycidyl ether (i.e., a compound of Formula (I) with p equal to 2). In other embodiments, the epoxy resin is a mixture of compounds of Formula (I) with p equal to 2 and compounds of Formula (I) with p not equal to 2. In such mixtures, the amount of the diglycidyl ether is often at least 50 weight percent, at least 60 weight percent, at least 70 weight percent, at least 75 weight percent, at least 80 weight percent, at least 85 weight percent, at least 90 weight percent, or at least 95 weight percent based on the total weight of the epoxy resin.

In most embodiments, the epoxy resin is free of compounds that have an oxirane group that is not a glycidyl group. If such compounds are included, however, they typically make up less than 30 weight percent, less than 20 weight percent, less than 10 weight percent, less than 5 weight percent, less than 2 weight percent, less than 1 weight percent, or less than 0.5 weight percent based on the total weight of the epoxy resin.

The first part contains at least 30 to 100 weight percent epoxy resin based on a total weight of the curable components in first part. If the first part contains less than 30 weight percent epoxy resin, there may be an insufficient amount of the epoxy resin to result in the preparation of a cured composition with a suitable overlap shear strength. The amount of the epoxy resin can be at least 30 weight percent, at least 35 weight percent, at least 40 weight percent, at least 45 weight percent, at least 50 weight percent, at least 60 weight percent, or at least 70 weight percent and can be up to 100 weight percent, up to 99 weight percent, up to 95 weight percent, up to 90 weight percent, up to 80 weight percent, up to 70 weight percent, up to 60 weight percent, or up to 50 weight percent based on a total weight of the curable components in the first part.

The amount of the epoxy resin in the filament article is often in a range of 40 to 90 weight percent based on a total weight of the curable components in the curable composition. The amount is often at least 40 weight percent, at least 45 weight percent, at least 50 weight percent, at least 55 weight percent, at least 60 weight percent, or at least 65 weight percent and up to 90 weight percent, up to 80 weight percent, up to 75 weight percent, up to 70 weight percent, up to 65 weight percent, or up to 60 weight percent based on the total weight of curable components in the curable composition.

### Polyamines in the Second Part

The polyamine functions as a curing agent for the epoxy resin. The polyamine has at least two amino groups that are primary and/or secondary amino groups. That is, the polyamine has reactive amine hydrogen (—NH) groups. The primary and/or secondary amino groups are often of formula —NHR² where R² is hydrogen or alkyl. The amino group is connected to a methylene (—CH₂—) group rather than to a carbonyl (—(CO)—) group. That is, the amino group is not part of an amide linkage. Any suitable polyamine can be used provided that the overall second part composition is a semi-solid. Preferably, the epoxy resin and the polyamine are miscible or form a stable macroscopic mixture when combined prior to deposition onto a substrate.

In some embodiments, the polyamine can be a polymeric material such as a poly(alkylene oxide) diamine (also called polyether diamines). Example poly(alkylene oxide) diamines include, for example, poly(ethylene oxide) diamines, poly(propylene oxide) diamines, or a copolymer thereof. Polyether diamines are commercially available under the trade designation JEFFAMINE from Huntsman Corporation (The Woodlands, Tex., USA) and under the trade designation DYNAMAR (e.g., DYNAMAR HC 1101) from 3M Company (Saint Paul, Minn., USA).

The polyamines can be amine-terminated polyamides. These polyamines can be prepared by reacting a diacid with a diamine. In some embodiments, the diamine is a polyether diamine and the diacid is a dimer acid. The amine-terminated polyamides based on dimer acids can be prepared as described in U.S. Pat. No. 5,629,380 (Baldwin et al.) and WO 2019/215533 (Yao et al.). A polymeric polyamine can be formed using this process, if desired.

Other polyamines can be amine-terminated oxamides. The oxamide can be prepared by reaction of dimer acid diamine (e.g., PRIAMINE 1075 commercially available from Croda Inc. (Chino Hills, Calif., USA)) with an oxalate such as diethyl oxalate to form an ethyl oxalate-terminated intermediate that is further reacted with another diamine such as a polyether diamine to form the amine-terminated oxamide. A polymeric polyamine can be formed using this process, if desired.

Still other polyamines can be an adduct formed by reacting an epoxy resin having at least two glycidyl groups with a polyamine such as a diamine to form a polyamine adduct having two terminal amino groups. When a diamine is reacted with an epoxy resin having two glycidyl groups, the molar ratio of diamine to epoxy resin is often greater than or equal to 2:1. A molar excess of the diamine (which can be polymeric, if desired) is often used so that the polyamine includes both the amine-containing adduct plus free (non-reacted) diamine (which can be polymeric, if desired). For example, the molar ratio of diamine to epoxy resin with two glycidyl groups can be greater than 2.5:1, greater than 3:1, greater than 3.5:1, or greater than 4:1. The reaction opens the glycidyl groups and covalently bonds the diamine to the epoxy resin. The reaction results in the formation of divalent groups of formula —OCH₂—CH₂—NR²— where R² is hydrogen or alkyl. A polymeric polyamine can be prepared using this process, if desired.

Other polyamines that can be used as the polyamine or in the preparation of higher molecular weight polyamides such as polyamide with terminal amino groups, oxamides with terminal epoxy groups, and polyamine adducts include, for example, ethylene diamine, diethylene triamine, triethylene tetramine, propylene diamine, dipropylene triamine, tetraethylene pentamine, hexaethylene heptamine, hexamethylene diamine, 2-methyl-1,5-pentamethylene diamine, 1-amino-3-aminomethyl-3,3,5-trimethylcyclohexane (also called isophorone diamine), 1,3 bis-aminomethylcyclohexane, 1,10-dimainodecane, 1,12-diaminododecene, aminoethylpiperazine, 4,7,10-trioxatridecane-1,13-diamine (TTD) (which is available from TCI America in Portland, Oreg., USA).

Still other polyamines are commercially available under the trade designation ANCAMINE (e.g., ANCAMINE 2609, which is described as being a nonyl phenol free aliphatic polyamine Mannich base curing agent, and ANCAMINE 2337S, which is described as being a modified aliphatic amine curing agent) from Evonik Corporation (Essen, North Rhine-Westphalia, Germany), meta-xylene diamine available under the trade designation ARADUR 2965 from Huntsman Corporation (The Woodlands, Tex., USA), and 4,4′-diaminodiphenyl sulfone (DDS) available as ARADUR 9964-1 from Huntsman Corporation.

Still other polyamines include hydrazine, hydrazide or derivatives thereof (e.g., amino dihydrazide, adipic dihydrazide, and isophthalyl dihydrazide), guanidines or derivatives thereof, and dicyanamide (DICY) or derivatives thereof.

The amount of the polyamine is dependent on its molecular weight and the second part often contains a mixture of different polyamines to obtain the desired viscosity. Further, the amount of the polyamine is also dependent on the number of amino groups (reactive amine hydrogen groups) per mole of the polyamine. Overall, the amount of the polyamine is often in a range of 10 to 60 weight percent based on a total weight of the curable components in the curable composition. For example, the amount can be at least 10 weight percent, at least 15 weight percent, at least 20 weight percent, at least 25 weight percent, at least 30 weight percent, at least 35 weight percent, or at least 40 weight percent and up to 60 weight percent, up to 55 weight percent, up to 50 weight percent, up to 45 weight percent, up to 40 weight percent, up to 35 weight percent, or up to 30 weight percent based on the total weight of the curable components in the curable composition.

The ratio of the equivalents of epoxy groups in the first part to the equivalents of active hydrogens on the polyamine in the second part is often in a range of 0.5 to 1.5. In some embodiments, the ratio is at least 0.6, at least 0.8, at least 0.9, at least 0.95, 1, up to 1.1, up to 1.2, up to 1.3, or up to 1.5. The ratio is often in a range of 0.8 to 1.2 or in a range of 0.9 to 1.1.

### Optional Curing Catalyst in the Second Part

The curable composition can optionally include a curing catalyst that can be in the second part. Examples of curing catalysts include phenols substituted with tertiary amino groups, bis-substituted urea compounds, sulfonic acid compounds or salts thereof, imidazoles or salts thereof, imidazolines or salts thereof, and Lewis acids. These compounds often accelerate reaction of the polyamines discussed above.

Some curing catalysts are phenols substituted with tertiary amino groups such as those of Formula (IV).

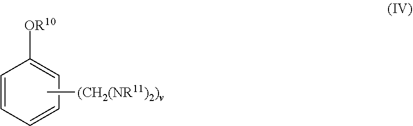

In Formula (IV), each group R¹¹ is independently an alkyl. The variable v is an integer equal to 2 or 3. Group R¹⁰ is hydrogen or alkyl. Suitable alkyl groups for R¹⁰ and R¹¹ often have 1 to 12 carbon atoms, 1 to 8 carbon atoms, 1 to 6 carbon atoms, or 1 to 4 carbon atoms. One exemplary secondary curative of Formula (IV) is tris-2,4,6-(dimethylaminomethyl)phenol that is commercially available under the trade designation ANCAMINE K54 from Evonik Corporation (Essen, North Rhine-Westphalia, Germany).

Another class of curing catalyst includes substituted ureas such as, for example, bis-substituted ureas. Examples include, but are not limited to, 4,4′-methylene bis(phenyl dimethyl) urea, toluene diisocyanate urea, 3-(4-chlorophenyl)-1,1-dimethylurea, and various compounds that are commercially available from CVC Thermoset Specialties (Moorestown, N.J., USA) under the trade designation OMICURE (e.g., OMICURE U-35 (which is a cycloaliphatic bis urea), U-52, and U-52M).

Yet another class of curing catalyst includes various sulfonic acidic compounds and salts thereof, such as those commercially available under the trade designation NACURE from King Industries, Inc. (Norwalk, Conn., USA).

Still other curing catalysts are imidazoles or salts thereof or imidazolines or salts thereof. A first type of these compounds can react with an epoxy resin at room temperature. A second type of these compounds can react with the epoxy resin after being heated above their melting point (e.g., above 150° C., above 170° C., or above 200° C.). The second type of compounds can be referred to as “latent curatives” or “blocked curatives.”

The first type of imidazole compounds (i.e., those that can react below their melting point) are often substituted at the 1-position or the 2-position of the imidazole ring. In epoxy systems, this type of imidazole compound can be used as accelerators or catalysts for other curing agents and can also act as curing catalysts for epoxy resins. Examples of those used as catalysts or accelerators include: 2-methyl-imidazole, 2-ethyl-4-methyl imidazole, 2-phenyl imidazole, 2-phenyl-4-methyl imidazole, 1,2-dimethylimidazole, 2-heptadecyl imidazole, 1-benzyl-2-methyl imidazole, 1-benzyl-2-phenyl-imidazole, and 2-phenyl-4,5-dihydroxymethyl imidazole.

The second type of imidazole compounds (i.e., those that can react above their melting point) are commercially available from Evonik Corporation (Essen, North Rhine-Westphalia, Germany) under the trade designation CUREZOL 2MZ Azine (which is 2,4-diamino-6(2′-methylimidazolyl-(1′))ethyl-s-triazine), and CUREZOL 2MA-OK (which is 2,4-diamino-6(2′-methylimidazolyl-(1′)(ethyl-s-triazine isocyanurate adduct))), and under the trade designation ARADUR 3123, which is 1-((2-methyl-1H-imidazol-1-yl)methyl)naphthalen-2-ol from Huntsman Corporation. Other imidazole compounds are metal imidazole salts such as those described in U.S. Pat. No. 4,948,449 (Tarbutton et al.).

Further compounds suitable for use as curing catalysts for epoxy resins are Lewis acids. Example Lewis acids include, but are not limited to, boron trifluoride (BF₃), boron trichloride (BCl₃), zinc chloride (ZnCl₂), stannic chloride (SnCl₄), antimony pentachloride (SbCl₅), antimony pentafluoride (SbF₅), ferric chloride (FeCl₃), aluminum trichloride (AlCl₃), arsenic pentafluoride (AsF₅), and phosphorous pentafluoride (PF₅). Due to their high reactivity, the Lewis acids are often complexed with a nitrogen-containing compound and/or with a hydroxy-containing compound. The molar ratio of the Lewis acid to the complexing agent is typically about 1:1 but can be higher depending on the specific Lewis acid and the selected complexing agent. Methods of preparing the Lewis acid complexes are described, for example, in U.S. Pat. No. 3,565,861 (White et al.), U.S. Pat. No. 4,503,161 (Korbel et al.), U.S. Pat. No. 4,503,211 (Robins), and U.S. Pat. No. 5,731,369 (Mahoney).

### Optional Film Forming Resin in the First Part, the Second Part, or Both

The curable composition can optionally further include a film-forming resin in the first part, in the second part, or in both parts. The film-forming resin is typically selected to be miscible with the epoxy resin in the first part and/or the polyamine in the second part. To be miscible means that the film-forming resin and either the epoxy resin or the polyamine do not macroscopically phase separate from each other. The film-forming resin can be used to adjust the viscosity of the first part and/or the second part so that the part is a semi-solid.

To avoid macroscopic phase separation from the epoxy resin and/or the polyamine, the film-forming resin typically has polar groups such as, for example, carbonyloxy groups (—(CO)—O—), carbonylamino groups (—(CO)—NH—), hydroxy groups (—OH), or ether groups (i.e., groups of formula —CH₂—O—CH₂—). Optionally, the film-forming resin can include reactive groups that can accelerate curing of the curable composition. Examples of reactive groups include, but are not limited to, carboxylic acid groups (—(CO)—OH), sulfonic acid groups (—(O═S═O)—OH), phosphonic acid groups (—(P═O)—OH—OH), and tertiary amino groups (—N(R)₂) where R is an alkyl). If these reactive groups are present, the film-forming resin is placed in a part that does not cause premature curing prior to formation of the molten composition.

Suitable exemplary film-forming resins include, for example, (meth)acrylate copolymers such as those having pendant hydroxy groups and/or pendant ether groups as well as various thermoplastic resins. Suitable thermoplastic film-forming resins include ethylene vinyl acetate resins, phenoxy resins, polyester resins, poly(vinyl ester) resins, poly(N-vinyl amide) resins, and polyether resins.

The amount of the optional film-forming resin that can be added to the curable composition is determined by such considerations as the required shear strength of the resulting structural adhesive composition and the viscosity of each part. The amount of the film-forming resin is often a range of 0 to 70 weight percent based on a total weight of curable components in the curable composition. The film-forming resin tends to increase the viscosity of the curable composition. If in addition to the film-forming resin, the curable components can further include other optional polymeric material such as a polyether polyol that tends to decrease the viscosity of the curable composition, then up to 70 weight percent of the curable components can be the film-forming resin. On the other hand, if the curable components do not include a polymeric material that lowers viscosity, then up to 50 weight percent of the curable components can be the film-forming resin. The upper limit may decrease further if fillers are added to the curable composition. The amount of the film-forming resin, if present, can be up to 70 weight percent, up to 60 weight percent, up to 50 weight percent, up to 40 weight percent, up to 30 weight percent, or up to 20 weight percent and at least 1 weight percent, at least 5 weight percent, at least 10 weight percent, at least 15 weight percent, or at least 20 weight percent based on the total weight of curable components in the curable composition. In some embodiments, the curable composition does not include or is substantially free (e.g., less than 1 weight percent, less than 0.5 weight percent, or less than 0.1 weight percent of the curable components) of the film-forming resin.

### (Meth)Acrylate Copolymers as Film Forming Resins

In some embodiments, the film-forming resin is a (meth)acrylate copolymer such as one having pendant hydroxy groups and/or pendant ether groups. The (meth)acrylate copolymers are often formed from a monomer mixture that includes a first monomer that is a (meth)acrylate monomer having a hydroxy or ether group (e.g., a cyclic ether group or a linear ether group) and a second monomer that is an alkyl (meth)acrylate.

The first monomer can be of Formula (II). These monomers have a cyclic ether group.

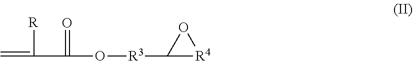

In Formula (II), group R is hydrogen or methyl. Group R³ is a single bond, alkylene, a group of formula —(R⁵—O—R⁵)ₙ— where R⁵ is an alkylene and n is an integer in a range of 1 to 10. Group R⁴ is an alkylene. Suitable alkylene groups for R³, R⁴, and R⁵ typically contain 1 to 10, 1 to 8, 1 to 6, 1 to 4, or 1 to 3 carbon atoms. The variable n can be at integer of at least 1, at least 2, or at least 3 and up to 10, up to 8, up to 6, or up to 4. When R³ is a single bond, the cyclic ether group is bonded directly to CH₂═CR²—(CO)—O— as in 2-tetrahydropyrany acrylate.

Some specific examples of first monomers of Formula (II) include tetrahydrofurfuryl (meth)acrylate, glycidyl (meth)acrylate, 4-hydroxybutyl (meth)acrylate glycidyl ether, and 2-tetrahydropyranyl (meth)acrylate.

In other embodiments, the first monomer is of Formula (III). These monomers have a hydroxy or ether group.

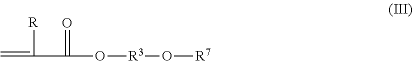

In Formula (III), group R is hydrogen or methyl. Group R⁶ is an alkylene, arylene, or a group of formula —(R⁸—O—R⁸)ₘ— where R⁸ is an alkylene and m is in integer in a range of 1 to 10 or even greater. Group R⁷ is hydrogen, alkyl, or aryl. Suitable alkylene groups for R⁶ and R⁸ typically contain 1 to 10, 1 to 8, 1 to 6, 1 to 4, or 1 to 3 carbon atoms. Suitable arylene groups for R⁶ often contain 6 to 12, 6 to 10, or 6 carbon atoms (e.g., phenylene). Suitable alkyl groups for R⁷ often contain 1 to 10, 1 to 6, 1 to 4, or 1 to 3 carbon atoms. Suitable aryl groups for R⁷ often contain 6 to 12, 6 to 10, or 6 carbon atoms (e.g., phenyl). The variable m can be at integer of at least 1, at least 2, or at least 3 and up to 10, up to 8, up to 6, up to 4, up to 3, or up to 2. If R⁷ is hydrogen, the first monomer has a hydroxy group; if R⁷ is alkyl or aryl, the first monomer has an ether group.

Some specific examples of first monomers of Formula (III) include hydroxyalkyl (meth)acrylates such as hydroxyethyl (meth)acrylate, hydroxypropyl (meth)acrylate, and hydroxybutyl (meth)acrylate, poly(propylene glycol) (meth)acrylate, and poly(ethylene glycol) (meth)acrylate (which can be ethoxylated hydroxyethyl (meth)acrylates).

The amount of the first monomer is often in a range of 30 to 80 weight percent based on the total weight of monomers used to form the (meth)acrylate copolymer. For example, the amount of the first monomer can be at least 30 weight percent, at least 40 weight percent, at least 45 weight percent, at least 50 weight percent, at least 55 weight percent, or at least 60 weight percent and up to 80 weight percent, up to 75 weight percent, up to 70 weight percent, up to 65 weight percent, up to 60 weight percent, up to 55 weight percent, or up to 50 weight percent,

The (meth)acrylate copolymer that can be used as a film-forming resin typically is formed from a monomer mixture that further contains a second monomer that is an alkyl (meth)acrylate. Examples of alkyl (meth)acrylate that can be used as the second monomer include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, isobornyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylates. In some embodiments, isomer mixtures of any of these monomers can be used. Monomers having an alkyl group with 1 to 8 carbon atoms may be preferred in some embodiments because the resulting (meth)acrylate copolymer may be more miscible with the epoxy resin.

The (meth)acrylate copolymer is often formed from a monomer mixture that contains 20 to 70 weight percent of the second monomer. The amount of the second monomer may be at least 20 weight percent, at least 25 weight percent, at least 30 weight percent, at least 35 weight percent, at least 40 weight percent, at least 45 weight percent, or at least 50 weight percent and up to 70 weight percent, up to 65 weight percent, up to 60 weight percent, up to 55 weight percent, or up to 50 weight percent based on a total weight of monomers used to form the (meth)acrylate copolymer.

The (meth)acrylate copolymer can be added to either the first part, the second part, or both. However, depending on the part to which it is added, the monomer mixture is typically selected to be free or substantially free of monomers that might prematurely initiate curing of the part. For example, if the (meth)acrylate copolymer is added to the curable composition in the first part, it is often preferable that the (meth)acrylate copolymer be prepared from a monomer mixture that is free or substantially free of acidic monomer, an amine-containing monomer, or a strongly basic monomer. These monomers can often be used, however, if the (meth)acrylate copolymer is in the second part. Acidic groups might prematurely initiate curing of the epoxy resin but (meth)acrylate copolymers with carboxylate, sulfate, phosphate, and phosphine groups can be used with the polyamine in the second part. Similarly, nitrogen-containing groups with an active hydrogen atom might prematurely initiate curing of the epoxy resin but (meth)acrylate copolymers with amide, lactam, urea, urethane, or —CH₂NHR⁹ groups where R⁹ is hydrogen or alkyl can be placed in the second part with the polyamine. On the other hand, strongly basic monomers may inhibit cationic curing of the epoxy resin. Thus, (meth)acylate copolymers added to the first part with the epoxy resin are usually free or substantially free of strongly basic groups but such (meth)acrylate copolymers can be added to the second part containing the polyamine.

Various methods of making the (meth)acrylate copolymer are well known to those of skill in the art. Any suitable method can be used. The weight average molecular weight of the (meth)acrylate copolymer is often in a range of 50,000 to 1,000,000 Daltons.

### Optional Thermoplastic Film Forming Resins

Various thermoplastic resins can be used as film-forming resins. These include, but are not limited to, ethylene vinyl acetate resins, phenoxy resins, polyester resins, poly(vinyl ester) resins, poly(N-vinyl amide) resins, and polyether resins.

In some embodiments, the thermoplastic film-forming resin is an ethylene-vinyl acetate (EVA) resin or similar polymers where a portion of the acetate groups have been converted by hydrolysis to hydroxy groups. Suitable ethylene-vinyl acetate copolymer resins often contain 28 to 90 weight percent (or even higher) vinyl acetate monomeric units based on a total weight of the EVA resin. For example, the EVA resin can contain at least 30 weight percent, at least 35 weight percent, at least 40 weight percent, at least 45 weight percent, at least 50 weight percent, at least 55 weight percent, or at least 60 weight percent and up to 90 weight percent (or even higher such as up to 95 weight percent or up to 99 weight percent), up to 85 weight percent, up to 80 weight percent, up to 75 weight percent, up to 70 weight percent, up to 65 weight percent, or up to 60 weight percent monomeric units of vinyl acetate. The EVA resin is often selected to contain 40 to 90 weight percent, 50 to 90 weight percent, or even 60 to 90 weight percent vinyl acetate monomeric units based on the total weight of the EVA resin.

Examples of commercially available ethylene-vinyl acetate copolymers that may be used include, but are not limited to, those available under the trade designation ELVAX from Dow Chemical Company (Midland, Mich., USA) such as ELVAX 150, 210, 250, 260, and 265, those available under the trade designation ATEVA series from Celanese, Inc. (Irving, Tex., USA), those available under the trade designation LEVAPREN from Arlanxeo USA (Pittsburgh, Pa., USA) such as LEVAPREN 400 with 40 weight percent vinyl acetate, LEVAPREN 450, 452, or 456 with 45 weight percent vinyl acetate, LEVAPREN 500 with 50 weight percent vinyl acetate, LEVAPREN 600 with 60 weight percent vinyl acetate, LEVAPREN 700 with 70 weight percent vinyl acetate, and LEVAPREN 800 with 80 weight percent vinyl acetate.

In some embodiments, the thermoplastic film-forming resin is a phenoxy resin that has one or more hydroxy groups. The phenoxy resins are often derived from the polymerization of a di-glycidyl bisphenol compound. Typically, the phenoxy resin has a number average molecular weight in a range of 20,000 to 60,000 Daltons. For example, the number average molecular weight is at last 20,000 Daltons, at least 30,000 Daltons, at least 40,000 Daltons and up to 60,000 Daltons, up to 50,000 Daltons, up to 40,000 Daltons, or up to 30,000 Daltons.

Commercially available phenoxy resins suitable for use as film-forming resins include, but are not limited to, those available from Gabriel (Akron, Ohio, USA) under the trade designation PHENOXY (e.g., PHENOXY PKHP-200) and those available from Milliken Chemical (Spartanburg, S.C., USA) under the trade designation SYNFAC (e.g., SYNFAC 8009, 773240, 8024, 8027, 8026, 8071 and 8031). The SYNFAC materials are polyoxyalkylated bisphenol A resins.

The thermoplastic film-forming resin can be a polyester resin such as semi-crystalline polyesters and amorphous polyesters. A material that is “amorphous” has a glass transition temperature but does not display a measurable crystalline melting point as determined using Differential Scanning calorimetry (DSC). Preferably, the glass transition temperature is less than about 100° C. A material that is “semi-crystalline” displays a crystalline melting point as determined by DSC, preferably with a maximum melting point of about 120° C.

Crystallinity in a polymer can also be reflected by the clouding or opaqueness of a sheet that had been heated to an amorphous state as it cools. When the polyester polymer is heated to a molten state and knife-coated onto a liner to form a sheet, it is usually amorphous initially and the sheet is observed to be clear and transparent to light. As the polymer in the sheet material cools, crystalline domains can form, and the crystallization is characterized by the clouding of the sheet to a translucent or opaque state. The degree of crystallinity may be varied in the polymers by mixing in any compatible combination of amorphous polymers and semi-crystalline polymers having varying degrees of crystallinity. It is generally preferred that material heated to an amorphous state be allowed enough time to return to its semi-crystalline state before use or application. The clouding of the sheet provides a convenient non-destructive method of determining that crystallization has occurred to some degree in the polymer.

The polyesters may include nucleating agents to increase the rate of crystallization at a given temperature. Useful nucleating agents include microcrystalline waxes. A suitable wax could include an alcohol comprising a carbon chain having a length of greater than 14 carbon atoms (CAS #71770-71-5) or an ethylene homopolymer (CAS #9002-88-4) sold by Baker Hughes, Houston, Tex., as UNILIN 700.

The polyester resins are typically solid at room temperature. Suitable polyester resins often have a number average molecular weight of about 7,500 Daltons to 200,000 Daltons. In some examples, the polyester resins having a number average molecular weight of at least 10,000 Daltons, at least 15,000 Daltons, at least 20,000 Daltons, at least 25,000 Daltons, at least 30,000 Daltons, or at least 50,000 Daltons and up to 200,000 Daltons, up to 100,000 Daltons, up to 80,000 Daltons, up to 60,000 Daltons, up to 50,000 Daltons, up to 40,000 Daltons, and up to 30,000 Daltons.

Useful polyesters include the reaction product of dicarboxylic acids (or their diester equivalents) and diols. The diacids (or diester equivalents) can be saturated aliphatic acids containing from 4 to 12 carbon atoms (including branched, unbranched, or cyclic materials having 5 to 6 carbon atoms in a ring) and/or aromatic acids containing from 8 to 15 carbon atoms. Examples of suitable aliphatic acids are succinic, glutaric, adipic, pimelic, suberic, azelaic, sebacic, 1,12-dodecanedioic, 1,4-cyclohexanedicarboxylic, 1,3-cyclopentanedicarboxylic, 2-methylsuccinic, 2-methylpentanedioic, 3-methylhexanedioic acids, and the like. Suitable aromatic acids include terephthalic acid, isophthalic acid, phthalic acid, 4,4′-benzophenone dicarboxylic acid, 4,4′-diphenylmethanedicarboxylic acid, 4,4′-diphenylthioether dicarboxylic acid, and 4,4′-diphenylamine dicarboxylic acid. Often, the structure between the two carboxyl groups in the diacids contain only carbon and hydrogen atoms. Blends of the foregoing diacids may be used.

The diols used to prepare the polyesters can include branched, unbranched, and cyclic aliphatic diols having from 2 to 12 carbon atoms. Examples of suitable diols include ethylene glycol, 1,3-propylene glycol, 1,2-propylene glycol, 1,4-butanediol, 1,3-butanediol, 1,5-pentanediol, 2-methyl-2,4-pentanediol, 1,6-hexanediol, cyclobutane-1,3-di(2′-ethanol), cyclohexane-1,4-dimethanol, 1,10-decanediol, 1,12-dodecanediol, and neopentyl glycol. Long chain diols including poly(oxyalkylene)glycols in which the alkylene group contains from 2 to 9 carbon atoms, 2 to 6 carbon atoms, or 2 to 4 carbon atoms may also be used. Blends of the foregoing diols may be used.

In many embodiments, the polyester resin are hydroxyl-terminated polyesters that are semi-crystalline at room temperature. Useful, commercially available hydroxyl terminated polyester materials include various saturated linear, semi-crystalline polyesters available from Evonik Corporation (Essen, North Rhine-Westphalia, Germany) under the trade designation DYNAPOL such as DYNAPOL S1401, DYNAPOL S1402, DYNAPOL S1358, DYNAPOL S1359, DYNAPOL S1227, and DYNAPOL S1229. Useful saturated, linear amorphous polyesters available from Evonik Corporation include DYNAPOL 1313 and DYNAPOL S1430.

Additional useful polyester resins include polycaprolactone polyols available under the trade designation TONE from Dow Chemical Company (Midland, Mich., USA), polycaprolactone polyols available under the trade designation CAPA from Perstorp Inc. (Perstorp, Sweden), and saturated polyester polyols available under the trade designation DESMOPHEN (e.g., DESMOPHEN 631A 75) of from Covestro (Leverkusen, Germany).

Still other thermoplastic film-forming resins include poly(vinyl ester) resins, poly(N-vinyl amides), and various polyether resins. Suitable poly(vinyl ester) resins include poly(vinyl acetate) and copolymers that as those commercially available from Wacker Chemie AG (Munich, Germany) under the trade designation VINNAPAS. Example poly(N-vinyl amide) film-forming resins include polyvinylpyrrolidone and polyvinyl caprolactam. Suitable polyethers film-forming resins include polyethylene glycol, polypropylene glycol, and polytetramethylene ether glycol.

### Other Optional Components

In some curable compositions, an optional organic solvent is included. Suitable organic solvents include, but are not limited to, methanol, tetrahydrofuran, ethanol, isopropanol, pentane, hexane, heptane, acetone, methyl ethyl ketone, methyl acetate, ethyl acetate, toluene, xylene, ethylene glycol alkyl ether, propylene carbonate, and mixtures thereof. The organic solvent can be added to dissolve a reactant in the curable composition, can be added to lower the viscosity of the curable composition to facilitate its dispensing, or can be a residue from the preparation of the (meth)acrylate copolymer. The amount of organic solvent is usually controlled so that both the first part and the second part are semi-solids. The amount of the organic solvent in the curable composition can be in a range of 0 to 10 weight percent based on a total weight of the curable composition. In some embodiments, the amount is at least 0.5 weight percent, at least 1 weight percent, at least 2 weight percent, at least 3 weight percent, at least 4 weight percent and up to 10 weight percent, up to 9 weight percent, up to 8 weight percent, up to 7 weight percent, up to 6 weight percent, or up to 5 weight percent.

The curable composition optionally contains a flow control agent or thickener, to provide the desired rheological characteristics to the composition. Silica is a thixotropic agent and is added to provide shear thinning Silica has the effect of lowering the viscosity of the curable composition when force (shear) is applied. When no force (shear) is applied, however, the viscosity seems higher. That is, the shear viscosity is lower than the resting viscosity. The silica typically has a longest average dimension that is less than 500 nanometers, less than 400 nanometers, less than 300 nanometers, less than 200 nanometers, or less than 100 nanometers. The silica particles often have a longest average dimension that is at least 5 nanometers, at least 10 nanometers, at least 20 nanometers, or at least 50 nanometers. In some embodiments, the silica particles are fumed silica such as treated fumed silica, available under the trade designation CAB-O-SIL TS 720, and untreated fumed silica available under the trade designation CAB-O-SIL M5, from Cabot Corporation (Alpharetta, Ga., USA). In other embodiments, the silica particles are non-aggregated nanoparticles.

If used, the amount of the optional silica particles is at least 0.5 weight percent based on a total weight of the curable composition. The amount of the silica can be at least 1 weight percent, at least 1.5 weight percent, or at least 2 weight percent and can be up to 10 weight percent, up to 8 weight percent, or up to 5 weight percent. For example, the amount of silica can be in a range of 0 to 10 weight percent, 0.5 to 10 weight percent, 1 to 10 weight percent, 0.5 to 8 weight percent, 1 to 8 weight percent, 0.5 to 5 weight percent, or 1 to 5 weight percent.

The curable composition can optionally include fibers for reinforcement of the cured composition. However, in many embodiments, the curable compositions are free or substantially free of fiber reinforcement. As used herein, “substantially free” means that the curable compositions contain no greater than 1 weight percent, no greater than 0.5 weight percent, no greater than 0.2 weight percent, no greater than 0.1 weight percent, no greater than 0.05 weight percent, or no greater than 0.01 weight percent of fibers.

In some embodiments, the curable composition optionally contains adhesion promoters to enhance the bond to the substrate. The specific type of adhesion promoter may vary depending upon the composition of the surface to which it will be adhered. Various silane and titanate compounds have been used to promote adhesion to the first substrate and/or the second substrate that are bonded together with the cured composition. If present, the amount of the adhesive promoter would be up to 5 weight percent, up to 3 weight percent, up to 2 weight percent, or up to 1 weight percent and at least 0.1 weight percent, at least 0.2 weight percent, or at least 0.5 weight percent based on the total weight of the curable composition.

Still other optional components include, for example, fillers (e.g., aluminum powder, carbon black, glass bubbles, talc, clay, calcium carbonate, barium sulfate, titanium dioxide, and mica), stabilizers, plasticizers, tackifiers, cure rate retarders, impact modifiers, toughening agents, expandable microspheres, glass beads or bubbles, thermally conductive particles, electrically conductive particles, fire retardants, antistatic materials, glass, pigments, colorants, and antioxidants. The optional components can be added, for example, to reduce the weight of the structural adhesive layer, to adjust the viscosity, to provide additional reinforcement, to modify the thermal or conductive properties, to alter the rate of curing, and the like. If any of these optional components are present, they are typically used in an amount that does not prevent the printing or dispensing of the curable composition.

Any of these additional optional components can be in the first part, the second part, or either providing they do not result in substantial curing of other components in these parts.

### Sheath

The sheath provides structural integrity to the filament article and protects the curable composition from premature curing. The sheath it typically selected to be thick enough to support the filament form factor and to allow delivery of the filament article to a deposition location. On the other hand, the thickness of the sheath is selected so that its presence does not adversely affect the overall structural adhesive performance of the cured composition.

The sheath material is typically selected to have a melt flow index (MFI) that is less than or equal to 15 grams/10 minutes when measured in accord with ASTM D1238-13 at 190° C. and with a load of 2.16 kilograms. Such a low melt flow index is indicative of a sheath material that has enough strength (robustness) to allow the filament article to withstand the physical manipulation required for handling, such as for use with an additive manufacturing apparatus. During such processes, the filament article often needs to be unwound from a spool, introduced into the additive manufacturing apparatus, and then advanced into a nozzle for melting and blending without breaking. Compared to sheath materials with a higher melt flow index, the sheath materials with a melt flow index that is less than or equal to 15 grams/10 minutes tend to be less prone to breakage (tensile stress fracture) and can be wound into a spool or roll having a relatively small radius of curvature. In certain embodiments, the sheath material exhibits a melt flow index of 14 grams/10 minutes or less, 13 grams/10 minutes or less, 11 grams/10 minutes or less, 10 grams/10 minutes or less, 8 grams/10 minutes or less, 7 grams/10 minutes or less, 6 grams/10 minutes or less, 5 grams/10 minutes or less, 4 grams/10 minutes or less, 3 grams/10 minutes or less, 2 grams/10 minutes or less, or 1 grams/10 minutes or less. If desired, various sheath materials can be blended (e.g., melted and mixed) together to provide a sheath composition having the desired melt flow index.

Low melt flow index values tend to correlate with high melt viscosities and high molecular weight. Use of higher molecular weight sheath material tends to result in better mechanical performance. That is, the sheath materials tend to be more robust (i.e., the sheath materials are tougher and less likely to undergo tensile stress fracture). This increased robustness is often the result of increased levels of polymer chain entanglements. The higher molecular weight sheath materials are often advantageous for additional reasons. For example, these sheath materials tend to migrate less to adhesive/substrate interface in the final article; such migration can adversely affect the adhesive performance, especially under aging conditions. In some cases, however, block copolymers with relatively low molecular weights can behave like high molecular weight materials due to physical crosslinks. That is, the block copolymers can have low MFI values and good toughness despite their relatively low molecular weights.

The sheath materials are often semi-crystalline polymers that can provide robust mechanical properties even at relatively low molecular weight such as 100,000 Daltons. That is, sheath materials with a weight average molecular weight of at least 100,000 Daltons can often provide the toughness and elongation needed to form a stable filament spool. In many embodiments, the weight average molecular weight is at least 150,000 Daltons, at least 200,000 Daltons, at least 300,000 Daltons, at least 400,000 Daltons, or even at least 500,000 Daltons. The molecular weight can go up to, for example, 2,000,000 Daltons or even higher or up to 1,000,000 Daltons. Higher molecular weight materials often advantageously have lower melt flow index values.

As the melt flow index is lowered (such as to less than or equal to 15 grams/10 minutes), less sheath material is required to obtain the desired mechanical strength. That is, the thickness of the sheath layer can be decreased and its contribution to the overall longest cross-sectional distance (e.g., diameter) of the filament article can be reduced. This is advantageous because the sheath material may adversely impact the adhesive properties of the final cured composition if it is present in an amount greater than about 10 weight percent of the total weight of the filament.

For application to a substrate, the filament article is typically melted and mixed together before deposition on the substrate. The sheath material desirably is blended with the curable composition without adversely impacting the performance of the resulting cured composition, which is often a structural adhesive. To blend the sheath and the curable composition within the first part and second part effectively, it is often desirable that the sheath composition is compatible with the curable composition. Because the curable contains an epoxy resin with polar groups, the use of sheath materials that include polar groups such as oxy groups, carbonyl groups, amido groups, or combinations thereof may be advantageous. However, the sheath and the curable components should not be miscible at room temperature or under storage conditions of the filament article. Further, the sheath composition is often selected so that is it not plasticized by components that might migrate from the first part and/or the second part. Plasticization of the sheath may increase its tackiness.

If the filament article is formed by co-extrusion of the first part and/or the second part of the curable composition and the sheath composition, the melt viscosity of the sheath composition is desirably selected to be comparable to that of the first part and/or second part of the curable composition. If the melt viscosities are not sufficiently similar (such as if the melt viscosity of the first part and/or the second part of the curable composition is significantly lower than that of the sheath composition), the sheath may not surround the first part and/or the second part in the filament article. The filament article can then have exposed first part and/or second part regions. Additionally, if the melt viscosity of the sheath composition is significantly higher than the first part and/or the second part, during melt blending of the curable composition and the sheath composition during dispensing, the non-tacky sheath may remain exposed (not blended sufficiently with the curable composition) and adversely impact formation of an adhesive bond with the substrate. The melt viscosities of the sheath composition to the melt viscosity of the first part and/or second part composition is in a range of 100:1 to 1:100, in a range of 50:1 to 1:50, in a range of 20:1 to 1:20, in a range of 10:1 to 1:10, or in a range of 5:1 to 1:5. In many embodiments, the melt viscosity of the sheath composition is greater than that of the first part and/or second part composition. In such situations, the melt viscosity of the sheath composition to the melt viscosity of the first part and/or second part composition is typically in a range of 100:1 to 1:1, in a range of 50:1 to 1:1, in a range of 20:1 to 1:1, in a range of 10:1 to 1:1, or in a range of 5:1 to 1:1.

The filament article typically contains 0.1 to 25 weight percent sheath based on a total weight of the filament article minus any optional filler. For example, the filament article contains at least 0.1 weight percent, at least 0.2 weight percent, at least 0.5 weight percent, at least 1 weight percent, at least 2 weight percent, at least 3 weight percent, at least 5 weight percent, or at least 10 weight percent and up to 25 weight percent, up to 20 weight percent, up to 15 weight percent, or up to 10 weight percent sheath minus any optional filler. The amount is often in a range of 0.5 to 20 weight percent, 1 to 15 weight percent, or 1 to 10 weight percent based a total weight of the filament article minus any optional filler.

In addition to exhibiting strength, the sheath material is non-tacky. A material is non-tacky if it passes a “Self-Adhesion Test”, in which the force required to peel the material apart from itself is at or less than a predetermining maximum threshold amount, without fracturing the material. The Self-Adhesion Test is described in the Examples below. Employing a non-tacky sheath allows the filament to be handled and optionally printed, without undesirably adhering to anything prior to deposition onto a substrate.

In certain embodiments, the sheath material exhibits a combination of low MFI (e.g., less than or equal to 15 grams/10 minutes) and moderate elongation at break (e.g., 100% or more as determined by ASTM D638-14 using test specimen Type IV) and low tensile stress at break (e.g., 10 MPa or more as determined by ASTM D638-14 using test specimen Type IV). A sheath having these properties tends to have the toughness suitable for use in FFF-type applications.

In some embodiments, to achieve the goals of providing structural integrity and a non-tacky surface, the sheath comprises a material selected from styrenic copolymers (e.g., styrenic block copolymers such as styrene-butadiene block copolymers), polyolefins (e.g., polyethylene, polypropylene, and copolymers thereof), ethylene vinyl acetates, polyurethanes, ethylene methyl acrylate copolymers, polyamides, (meth)acrylic block copolymers, poly(lactic acids), and the like. Depending on the method of making the filament article, it may be advantageous to at least somewhat match the polarity of the sheath polymeric material with that of the first part and/or the second part.

The sheath material is usually selected so that it is not miscible with the first part and/or the second part at room temperature or under storage conditions for the filament article. It can be desirable, however, if the first part and/or the second part and the sheath are miscible under molten conditions. Further, it is desirable that the sheath does not become tacky by being in contact with the first part and/or the second part prior to use of the filament article.

Suitable styrenic materials for use in the sheath are commercially available and include, for example and without limitation, styrenic materials under the trade designation KRATON (e.g., KRATON D116 P, D1118, D1119, and A1535) from Kraton Performance Polymers (Houston, Tex., USA), under the trade designation SOLPRENE (e.g., SOLPRENE S-1205) from Dynasol (Houston, Tex., USA), under the trade designation QUINTAC from Zeon Chemicals (Louisville, Ky., USA), under the trade designations VECTOR and TAIPOL from TSRC Corporation (New Orleans, La., USA), and under the trade designations K-RESIN (e.g., K-RESIN DK11) from Ineos Styrolution (Aurora, Ill., USA).

Suitable polyolefins are not particularly limited and include, for example, polypropylene (e.g., a polypropylene homopolymer, a polypropylene copolymer, and/or blends comprising polypropylene) or polyethylene (e.g., a polyethylene homopolymer, a polyethylene copolymer, high density polyethylene (“HDPE”), medium density polyethylene (“MDPE”), low density polyethylene (“LDPE”), and combinations thereof). For instance, suitable commercially available LDPE resins include PETROTHENE NA217000 available from LyondellBasell (Rotterdam, Netherlands) with an MFI of 5.6 grams/10 minutes and MARLEX 1122 available from Chevron Phillips (The Woodlands, Tex., USA). Suitable HDPE resins include ELITE 5960G from Dow Chemical Company (Midland, Mich., USA) and HDPE HD 6706 series from ExxonMobil (Houston, Tex., USA). Polyolefin block copolymers are available from Dow Chemical Company under the trade designation INFUSE (e.g., INFUSE 9807).

Suitable commercially available thermoplastic polyurethanes include, for instance, ESTANE 58213 and ESTANE ALR 87A available from the Lubrizol Corporation (Wickliffe, Ohio, USA).

Suitable ethylene vinyl acetate (“EVA”) polymers (i.e., copolymers of ethylene with vinyl acetate) for use in the sheath include resins from Dow Chemical Company (Midland, Mich., USA) available under the trade designation ELVAX. Typical grades range in vinyl acetate content from 9 to 40 weight percent and a melt flow index of as low as 0.3 grams/10 minutes (per ASTM D1238-13). One exemplary material is ELVAX 3135 SB with an MFI of 0.4 grams/10 minutes. Suitable EVAs also include high vinyl acetate ethylene copolymers from LyondellBasell (Houston, Tex.) available under the trade designation ULTRATHENE. Typical grades range in vinyl acetate content from 12 to 18 weight percent. Suitable EVAs also include EVA copolymers from Celanese Corporation (Dallas, Tex.) available under the trade designation ATEVA. Typical grades range in vinyl acetate content from 2 to 26 weight percent.

Suitable polyamide materials for use in the sheath include nylon (e.g., nylon 6,6), a nylon terpolymeric material from Nylon Corporation of America (Manchester, N.H., USA) under the trade designation NYCOA (e.g., NYCOA XN-287-CAY with an MFI of 5.1 grams/10 minutes), and a polyamide-polyether block copolymer such as that commercially available under the trade designation PEBAX (e.g., PEBAX MV 1074SA) from Arkema Inc. (King of Prussia, Pa., USA).

Suitable poly(ethylene methyl acrylate) for use in the sheath include resins from Dow Chemical Company (Midland, Mich., USA) under the trade designation ELVALOY (e.g., ELVALOY 1330 with 30 percent methyl acrylate and an MFI of 3.0 grams/10 minutes, ELVALOY 1224 with 24 percent methyl acrylate and an MFI of 2.0 grams/10 minutes, and ELVALOY 1609 with 9 percent methyl acrylate and an MFI of 6.0 grams/10 minutes).

Suitable anhydride modified ethylene acrylate resins are available from Dow Chemical Company under the trade designation BYNEL such as BYNEL 21E533 with an MFI of 7.3 grams/10 minutes and BYNEL 30E753 with an MFI of 2.1 grams/10 minutes.

Suitable ethylene (meth)acrylic copolymers for use in the sheath include resins from Dow Chemical Company under the trade designation NUCREL (e.g., NUCREL 925 with an MFI of 25.0 grams/10 minutes and NUCREL 3990 with an MFI of 10.0 grams/10 minutes). The NUCREL 925 can be used if it is blended with another polymeric material such that the blend has lower MFI such as no greater than 15 grams/10 minutes.

Suitable (meth)acrylic block copolymers for use in the sheath include block copolymers from Kuraray (Chiyoda-ku, Tokyo, JP) under the trade designation KURARITY (e.g., KURARITY LA2250 and KURAITY LA4285). KURARITY LA2250, which has an MFI of 22.7 grams/10 minutes, is an ABA block copolymer with poly(methyl methacrylate) as the A blocks and poly(n-butyl acrylate) as the B block. About 30 weight percent of this polymer is poly(methyl methacrylate). The KURARITY LA2250 can be used in the sheath provided it is blended with another sheath material having a lower MFI such as, for example, KURARITY LA4285 so that the blend has an MFI that is no greater than 15 grams/10 minutes. KURARITY LA4285, which has an MFI of 1.8 grams/10 minutes, is an ABA block copolymer with poly(methyl methacrylate) as the A blocks and poly(n-butyl acrylate as the B block. About 50 weight percent of this polymer is poly(methyl methacrylate). Varying the amount of poly(methyl methacrylate) in the block copolymer alters its glass transition temperature and its toughness.

Suitable poly(lactic acid) for use in the sheath include those available from Natureworks, LLC (Minnetonka, Minn., USA) under the trade designation INGEO (e.g., INGEO 4043D General Purpose Fiber grade).

The cross-sectional view of an example filament article is in FIG. 1. The first part 12 and the second part 22 are each surrounded by a sheath 14 or 24 respectively to form two separate filaments 10 and 20. Each of the separate filaments can be prepared by co-extrusion of the first part or the second part with the sheath material. Alternatively, each of the separate filaments can be prepared by forming the first part or the second part, which are each a semi-solid, and wrapping the sheath material around the first part or second part to enclose the part within the sheath. The sheath material used to surround the first part can be the same or different than the sheath material used to surround the second part.

FIG. 2 is a cross-sectional view of an example composite filament article 30 where the first part 31 is surrounded by sheath 34 and the second part 33 is surrounded by the sheath 35. The sheath separates the first part from the second part. Sheaths 34 and 35 can be of the same or different materials. This composite filament can be prepared in any known manner. For example, the two separate filaments of FIG. 1 can be adhered to each other. Alternatively, the two separate filaments can be wound or twisted around each other to form a spiral composite filament.

FIG. 3 is the cross-sectional view of another example filament article 40 where the first part 41 is surrounded by the first sheath 42 and where the second part 43 is positioned between the first sheath 42 and a second sheath 44. The first sheaths 42 separates the first part 41 from the second part 43 while the second sheath 44 constrains the second part 43. The first sheath 42 and the second sheath 44 can be formed of the same or different non-tacky thermoplastic resin. The filament article 40 can be prepared by co-extrusion of the first part 41, the first sheath 42, the second part 43, and the second sheath 44. Alternatively, the first sheath 42 can be wrapped around the first part 41, the second part 43 can be wrapped around the first sheath 42, and the second sheath 44 can be wrapped around the second part 43.

FIG. 4 is the cross-sectional view of yet another example filament article 50 that contains a composite filament. The composite filament contains a first part 51 and a second part 53 that are separated by a sheath 54. The sheath surrounds both the first part 51 and the second part 53. The first part 51 is separated from the second part 53. The filament article can be prepared by co-extrusion of the first part, the second part, and the sheath. Alternatively, the first part can be surrounded by a sheath, the second part can be surrounded by the sheath, and the sheaths around the first part can be attached to the sheath material around the second part. The sheath material surrounding the first part 51 and the second part 53 can be the same or different.

The filament article can include more than one first part and/or more than one second part. Each first part and each second part is surrounded by sheath material to prevent mixing of the parts prior to deposition onto a substrate.

In some embodiments, the first part and/or the second part is tacky to the touch. While this is desirable if the first part and/or the second part are wrapped with the sheath material to form the filament article, tackiness is optional if the filament article is prepared by extrusion.

### Method of Printing and Bonding

In another aspect, a method of printing and bonding is provided. The method includes providing a filament article containing a curable composition as described above. The method further includes melting and blending the filament article to form a molten composition. Preferably, the filament article is uniformly blended in the molten composition. The method still further includes dispensing the molten composition through a nozzle onto at least a first portion of a first substrate. The method yet further includes positioning either a second substrate or a second portion of the first substrate in contact with the molten composition and forming a structural adhesive bond between at least the first portion of the first substrate and either the second substrate or the second portion of the first substrate.

Fused Filament Fabrication, which is also known under the trade designation “FUSED DEPOSITION MODELING” from Stratasys, Inc., Eden Prairie, Minn., is a process that uses a thermoplastic strand fed through a hot can to produce a molten aliquot of material from an extrusion head. The extrusion head extrudes a bead of material in 3D space as called for by a plan or drawing (e.g., a computer aided drawing (CAD file)). The extrusion head typically lays down material in layers, and after the material is deposited, it fuses.

One suitable method for printing a filament article comprising a curable composition onto a substrate is a continuous non-pumped filament fed dispensing unit. In such a method, the dispensing throughput is regulated by a linear feed rate of the filament article allowed into the dispense head. In most currently commercially available FFF dispensing heads, an unheated filament is mechanically pushed into a heated zone, which provides adequate force to push the filament out of a nozzle. A variation of this approach is to incorporate a conveying screw in the heated zone, which acts to pull in a filament from a spool and to create pressure to dispense the material through a nozzle. Although addition of the conveying screw into the dispense head adds cost and complexity, it does allow for increased throughput, as well as the opportunity for a desired level of component mixing and/or blending. A characteristic of filament fed dispensing is that it is a true continuous method, with only a short segment of filament in the dispense head at any given point.

There can be several benefits to filament fed dispensing methods compared to traditional hot melt deposition methods. First, filament fed dispensing methods typically permits quicker changeover to different curable compositions. Also, these methods do not use a semi-batch mode with melting tanks, and this minimizes the opportunity for premature curing of the curable composition. Filament fed dispensing methods can use materials with higher melt viscosity, which can result in depositions having excellent geometric precision and stability. In addition, higher molecular weight raw materials as well as fillers can be used because of the higher allowable melt viscosity.

The form factor for FFF filaments is usually a concern. For instance, consistent cross-sectional shape and longest cross-sectional distance (e.g., diameter) assist in cross-compatibility of the filament articles with existing standardized FFF filaments such as ABS or polylactic acid (PLA). In addition, consistent longest cross-section distance (e.g., diameter) helps to ensure the proper throughput because the FFF dispense rate is generally determined by the feed rate of the linear length of a filament. Suitable longest cross-sectional distance variation of the filament article according to at least certain embodiments when used in FFF includes a maximum variation of 20 percent over a length of 50 cm, or even a maximum variation of 15 percent over a length of 50 cm.

Extrusion-based layered deposition systems (e.g., fused filament fabrication systems) are useful for making articles including printed curable composition in methods of the present disclosure. Deposition systems having various extrusion types of are commercially available, including single screw extruders, twin screw extruders, hot-end extruders (e.g., for filament feed systems), and direct drive hot-end extruders (e.g., for elastomeric filament feed systems). The deposition systems can also have different motion types for the deposition of a material, including using XYZ stages, gantry cranes, and robot arms. Common manufacturers of additive manufacturing deposition systems include Stratasys, Ultimaker, MakerBot, Airwolf, WASP, MarkForged, Prusa, Lulzbot, BigRep, Cosin Additive, and Cincinnati Incorporated. Suitable commercially available deposition systems include for instance and without limitation, BAAM, with a pellet fed screw extruder and a gantry style motion type, available from Cincinnati Incorporated (Harrison, Ohio); BETABRAM Model P1, with a pressurized paste extruder and a gantry style motion type, available from Interelab d.o.o. (Senovo, Slovenia); AM1, with either a pellet fed screw extruder or a gear driven filament extruder as well as a XYZ stages motion type, available from Cosine Additive Inc. (Houston, Tex.); KUKA robots, with robot arm motion type, available from KUKA (Sterling Heights, Mich.); and AXIOM, with a gear driven filament extruder and XYZ stages motion type, available from AirWolf 3D (Fountain Valley, Calif.).

Three-dimensional articles including a printed curable composition can be made, for example, from computer-aided design (CAD) models in a layer-by-layer manner by extruding a molten curable composition onto a substrate. Movement of the extrusion head with respect to the substrate onto which the curable composition is extruded is performed under computer control, in accordance with build data that represents the final article. The build data is obtained by initially slicing the CAD model of a three-dimensional article into multiple horizontally sliced layers. Then, for each sliced layer, the host computer generates a build path for depositing roads of the composition to form the three-dimensional article having a printed curable composition thereon. In select embodiments, the printed curable composition comprises at least one groove formed on a surface of the printed curable composition. Optionally, the printed curable composition forms a discontinuous pattern on the substrate.

The substrate onto which the molten curable composition is deposited is not particularly limited. In many embodiments, the substrate comprises a polymeric part, a glass part, or a metal part. Use of additive manufacturing to print a curable composition on a substrate may be especially advantageous when the substrate has a non-planar surface, for instance a substrate having an irregular or complex surface topography.

The filament article can be extruded through a nozzle carried by an extrusion head and deposited as a sequence of roads on a substrate in an x-y plane. The extruded molten curable composition fuses to previously deposited molten curable composition as it solidifies upon a drop-in temperature. This can provide at least a portion of the printed curable composition. The position of the extrusion head relative to the substrate is then incremented along a z-axis (perpendicular to the x-y plane), and the process is repeated to form at least a second layer of the molten curable composition on at least a portion of the first layer. Changing the position of the extrusion head relative to the deposited layers may be carried out, for example, by lowering the substrate onto which the layers are deposited. The process can be repeated as many times as necessary to form a three-dimensional article including a printed curable composition resembling the CAD model. Further details can be found, for example, Turner, B. N. et al., “A review of melt extrusion additive manufacturing processes: I. process design and modeling”; Rapid Prototyping Journal 20/3 (2014) 192-204. In certain embodiments, the printed curable composition comprises an integral shape that varies in thickness in an axis normal to the substrate. This is particularly advantageous in instances where a shape of curable composition is desired that cannot be formed using die-cutting of a curable composition. In certain embodiments a single curable composition layer may be advantageous to minimize the amount of curable composition that is consumed or to minimize the thickness of the bond line.

A variety of fused filament fabrication 3D printers may be useful for carrying out the method according to the present disclosure. Many of these are commercially available under the trade designation “FDM” from Stratasys, Inc., Eden Prairie, Minn., and subsidiaries thereof. Desktop 3D printers for idea and design development and larger printers for direct digital manufacturing can be obtained from Stratasys and its subsidiaries, for example, under the trade designations “MAKERBOT REPLICATOR”, “UPRINT”, “MOJO”, “DIMENSION”, and “FORTUS”. Other 3D printers for fused filament fabrication are commercially available from, for example, 3D Systems, Rock Hill, S.C., and Airwolf 3D, Costa Mesa, Calif.

In certain embodiments, the method further comprises mixing the molten composition (e.g., mechanically) prior to dispensing the molten composition. In other embodiments, the process of being melted in and dispensed through the nozzle may provide sufficient mixing of the composition such that the molten composition is mixed in the nozzle, during dispensing through the nozzle, or both.

The temperature of the substrate onto which the curable composition can be deposited may also be adjusted to promote the fusing of the deposited curable composition. In the method according to the present disclosure, the temperature of the substrate may be, for example, at least about 100° C., 110° C., 120° C., 130° C., or 140° C. up to 175° C. or 150° C.

The molten composition is dispensed on at least a first portion of a first substrate. Either a second substrate or a second portion of the first substrate is positioned in contact with the molten composition. The method results in the formation of a structural adhesive bond between at least the first portion of the first substrate and either and the second substrate or the second portion of the first substrate.

The resulting bonded article can be useful in a variety of industries, for example, the apparel, architecture, business machines products, construction, consumer, defense, dental, electronics, educational institutions, heavy equipment, industrial, jewelry, medical, toys industries, and transportation (automotive, aerospace, and the like).

### EMBODIMENTS

Various embodiments are provided that include filament articles, methods of making the filament articles, and methods of printing and bonding with the filament articles. The curable compositions with the filament articles can function to form a structural bond between two substrates or different portions of the same substrate.

Embodiment 1A is a filament article containing a curable composition. The curable composition contains a first part and a second part that is separated from the first part. The first part contains an epoxy resin while the second part contains a polyamine having at least two primary or secondary amino groups. The filament article further includes a sheath that contains a thermoplastic resin that is non-tacky and that surrounds each of the first part and the second part. Either 1) the first part surrounded by the sheath and the second part surrounded by the sheath are each a separate filament or 2) the first part surrounded by the sheath and the second part surrounded by the sheath combine to form a composite filament.

Embodiment 2A is the filament article of embodiment 1A, wherein the first part surrounded by the sheath and the second part surrounded by the sheath are each a separate filament.

Embodiment 3A is the filament article of embodiment 1A, wherein the first part surrounded by the sheath and the second part surrounded by the sheath combine to form a composite filament.

Embodiment 4A is the filament article of any one of embodiments 1A to 3A, wherein the filament article comprises 0.1 to 25 weight percent sheath based on a total weight of the filament article minus any optional filler.

Embodiment 5A is the filament article of any one of embodiments 1A to 4A, wherein the first part and the second part are semi-solids.

Embodiment 6A is the filament article of any one of embodiments 1A to 6A, wherein the filament article comprises 40 to 90 weight percent epoxy resin and 10 to 60 weight percent polyamine based on a total weight of curable components in the curable composition.

Embodiment 7A is the filament article of any one of embodiments 1A to 6A, wherein the polyamine comprises an amine-terminated oxamide and/or a polyether diamine.

Embodiment 8A is the filament article of any one of embodiments 1A to 7A, wherein a ratio equivalents of epoxy groups in the first part to equivalents of active hydrogen atoms on the polyamine in the second part are in a range of 0.8 to 1.2.

Embodiment 9A is the filament article of any one of embodiments 1A to 8A, wherein the first part and/or the second part further comprises a film-forming resin.

Embodiment 10A is the filament article of embodiment 9A, wherein the film-forming resin is a thermoplastic material.

Embodiment 11A is the filament article of embodiment 9A, wherein the film-forming resin is a (meth)acrylate copolymer.

Embodiment 12A is the filament article of anyone of embodiments 1A to 11A, wherein the sheath has a melt flow index that is less than or equal to 15 grams/10 minutes when measured in accord with ASTM D1238-13 at 190° C. and with a load of 2.16 kilograms.

Embodiment 1B is a method of making a filament article containing a curable composition. The method includes forming (or providing) a first part that contains an epoxy resin and forming (or providing) a second part that is separated from the first part and that contains a polyamine having at least two primary or secondary amino group. The method further includes surrounding each of the first part and the second part with a sheath that includes a thermoplastic resin that is non-tacky. Either 1) the first part surrounded by the sheath and the second part surrounded by the sheath are each a separate filament or 2) the first part surrounded by the sheath and the second part surrounded by the sheath combine to form a composite filament.

Embodiment 2B is the method of embodiment 1B, wherein the first part surrounded by the sheath and the second part surrounded by the sheath are each a separate filament.

Embodiment 3B is the method of embodiment 1B, wherein the first part surrounded by the sheath and the second part surrounded by the sheath combine to form a composite filament.

Embodiment 1C is a method of printing and bonding. The method includes providing a filament article containing a curable composition as described above in the first aspect. The method further includes melting and blending the filament article to form a molten composition. The method still further includes dispensing the molten composition through a nozzle onto at least a first portion of a first substrate. The method yet further includes positioning either a second substrate or a second portion of the first substrate in contact with the molten composition and forming a structural adhesive bond between at least the first portion of the first substrate and either the second substrate or the second portion of the first substrate.

Embodiment 2C is the method of embodiment 1C, wherein the filament article is in accord with anyone of embodiments 1A to 18A.

### EXAMPLES

Unless otherwise noted or readily apparent from the context, all parts, percentages, ratios, etc. in the Examples and the rest of the specification are by weight.

TABLE 1
Materials Used in the Examples

| Abbreviation | Description and Source |
|---|---|
| E-828 | A diglycidyl ether of bisphenol-A epoxy resin, can be obtained under the |
| | trade designation “EPON Resin 828” from Hexion Inc., Columbus, OH, |
| | USA |
| E-1001F | A diglycidyl ether of bisphenol-A epoxy resin, can be obtained under the |
| | trade designation “EPON Resin 1001F” from Hexion Inc., Columbus, OH, |
| | USA |
| GPTMS | 3-(Glycidoxypropyl) trimethoxysilane, obtained from United Chemical |
| | Technologies, Inc., Bristol, PA, USA |
| THFA | Tetrahydrofurfuryl acrylate, obtained under the trade designation |
| | “VISCOAT 150” from San Esters Corporation, New York, NY, USA |
| BDK | Benzyldimethyl ketal photoinitiator, obtained under the trade designation |
| | “OMNIRAD BDK” from IGM Resins USA Inc., Charlotte, NC, USA |
| IOTG | Isooctyl thioglycolate obtained from Evans Chemetics, LP, Teaneck, NJ, |
| | USA |
| BA | Butyl Acrylate, available from BASF Corporation, Florham Park, NJ, USA |
| EMA | A copolymer of ethylene and methyl acrylate, obtained under the trade |
| | designation “ELVALOY AC 1224” from Dow Inc., Midland, MI, USA |
| TTD | 4,7,10-Trioxa-1,13-tridecanediamine, obtained from TCI America, Portland, |
| | OR, USA |
| DEOX | Diethyloxalate, obtained from TCI America, Portland, OR, USA |
| 1075 | High-purity dimer acid diamine, obtained under the trade name “PRIAMINE |
| | 1075” from Croda Inc., Chino Hills, CA, USA |
| HC1101 | A branched diamine poly(tetrahydrofuran) with primary (1°) amine content |
| | of 7143 g/eq and total amine content of 5243 g/eq) obtained under the trade |
| | name “DYNAMAR HC-1101” from 3M Advanced Materials Division, St. |
| | Paul, MN, USA |
| 2337s | A modified aliphatic amine obtained under the trade designation |
| | “ANCAMINE 2337S” from Evonik Corporation, Essen, North Rhine- |
| | Westphalia, Germany |
| PVOH | Polyvinyl alcohol obtained under the trade designation “SELVOL 523S” |
| | from Sekisui Specialty Chemicals America, LLC, Dallas, TX, USA |
| Glycerol | Glycerine ≥99.7%, Laboratory Reagent, obtained from VWR Chemicals |
| | BDH, Radnor, PA, USA |

### Experimental Methods

### Dynamic Shear Test Specimen Preparation

Aluminum substrates 1.00 inch by 4.00 inch by 0.062 inch (25.4 mm by 101.7 mm by 1.56 mm) were lightly abraded with a SCOTCH-BRITE Light Cleansing Hand Pad 7445 (3M, Saint Paul, Minn.) for 30 seconds, washed with a continuous stream of isopropyl alcohol for 5 seconds, and wiped dry using a WYPALL L30 general purpose wipe (Kimberly-Clark Worldwide, Inc. Roswell, Ga., USA). Adhesive samples (EX-1, EX-2, and CE-A) were applied to a 0.50 inch by 1.00 inch (12.7 mm by 24.5 mm) patch of the abraded surface of the aluminum substrate immediately after compounding. Bond line thickness was controlled using two pieces of steel wire (Precision Brand Products, Downers Grove, Ill., USA) 0.16 mm in diameter and 30 mm in length oriented parallel to the long axis of the substrate placed in the bonding area. Bonds were closed by applying a second substrate overlapping in the region where the adhesive was applied such that the length of overlap was 0.50 inch (12.7 mm) and securing in place with two 0.75 inch (19 mm) binder clips. Six test specimens were prepared for each EX-1, EX-2, and CE-A. Three specimens were evaluated by the Dynamic Shear test method below immediately to access the initial green bond strength, and the remaining three were cured at 90° C. in a forced air oven for 1 hour before testing.

### Dynamic Shear Test

Dynamic overlap shear (OLS) test was performed at ambient temperature using an MTS CRITERION model 43 load frame (MTS, Eden Prairie, Minn.), using Advantage pneumatic grips and a 1 kN load cell for precured samples or Advantage wedge action grips and a 10 kN load cell for cured samples. Test specimens were loaded into the grips and the crosshead was operated at speed of 1.3 mm (0.05 in.)/min., loading the specimen to failure. Load and crosshead displacement were measured as a function of time through the test. The peak load recorded was averaged for three test specimens for each adhesive sample and was combined with the over lab area to calculate a peak stress that is taken to be the adhesive overlap shear strength.

### Rheometric Test Method

The storage modulus (G′), loss modulus (G″) and the complex viscosity (η*) of the core compositions were characterized by oscillatory rheometry using a TA Instruments Discovery Hybrid Rheometer 3 (TA Instruments, New Castle, Del.) equipped with an 8 mm stainless steel parallel plate upper geometry and a TA instruments DHR & AR-Series Advanced Peltier Plate as the lower geometry and for temperature control. Samples approximately 1 milliliter in volume were loaded onto the lower geometry and warmed to 60° C. The upper geometry was brought to a gap height of 1.050 mm and excess sample was trimmed away before the upper geometry was lowered to a final gap height of 1.000 mm. Individual samples were thermally equilibrated in the instrument at 25° C. for 300 seconds before testing. The frequency dependent flow behavior of the mixtures was investigated at 25° C. using a logarithmic sweep at 0.1% strain from 0.01-100 Hertz (Hz) selecting 10 individual rates per decade.

### Tensile Testing Polymer Dogbone for Strain Elongation at Break

Tensile testing was performed in accordance with “ASTM Standard D638-10: Standard Test Method for Tensile Properties of Plastics” using the following test parameters.
Specimen Type: Type IV dogbone (thickness shown in Table 3)
Test Apparatus: 100 kN MTS electromechanical load frame with pneumatic grips and ARAMIS digital image correlation system
Load Cell: 2.5 kN Load Capacity MTS
Crosshead Displacement (Nominal Strain Rate): 50.8 mm/min (2 inches/min)
Pre-Test Conditioning: 23° C./50% Relative Humidity
Atmospheric Conditions During Testing: 22° C./39% Relative Humidity
Sample Size: A minimum of five test specimens were tested for each sample

Extensometer Description: ARAMIS 4M 3D Digital Image Correlation System with Titanar 2 mm camera lenses and ARAMIS Professional analysis software

### Self-Adhesion Test Method and Results

The Self-Adhesion Test was conducted on films of the sheath material to determine whether candidate sheath materials would meet the requirement of being “non-tacky”. Coupons (25 millimeters x 75 millimeters x 0.8 millimeters) were cut out. For each material, two coupons were stacked on each other and placed on a flat surface within an oven. A 750 gram weight (43 millimeters diameter, flat bottom) was placed on top of the two coupons, with the weight centered over the films. The oven was heated to 50° C., and the samples were left at that condition for 4 hours, and then cooled to room temperature. A static T-peel test was used to evaluate pass/fail. The end of one coupon was fixed to an immobile frame, and a 250 gram weight was attached to the corresponding end of the other coupon with a binder clip. If the films were flexible and began to peel apart, they formed a T-shape. If the two coupons could be separated with the static 250 gram load within 3 minutes of applying the weight to the second coupon, it was considered a pass and was non-tacky. Otherwise, if the two coupons remained adhered, it was considered a fail. EMA was evaluated and passed the Self-Adhesion Test.

### Melt Flow Index Test Method

Melt flow index (MFI) was conducted on all samples following the method set forth in ASTM D1238-13 (Standard Test Method for Melt Flow Rates of Thermoplastics by Extrusion 5 Platometer, latest revision in 2013), Procedure A. The equipment used was a Tinius Olsen MP 987 Extrusion Plastometer (Melt Indexer), with the standard die dimensions for Procedure A. Conditions for the test were a temperature of 190° C. and a weight of 2.16 kg. A total of 8-19 replicates were performed to determine statistics, namely average MFI (in units of g/10 minutes), standard deviation of the MFI, and the 95% confidence interval about the mean.

The MFI of a polymer blend can be approximated from the respective MFI's of the homopolymers using the following method:

log(MFI_{Final})=X1*log(MFI₁)+X2*log(MFI₂)

where X₁ and X₂ are the weight fractions of each polymer X, and the MFI₁ and MFI₂ are the melt flow indices of the virgin polymer.

### Preparative Example

### Preparative Acrylic Copolymer (PA-1)

An acrylic copolymer was prepared using the method of Hamer (U.S. Pat. No. 5,804,610). Solutions were prepared by combining 50 parts by weight (pbw) each of BA and THFA acrylic monomers, BDK photoinitiator (0.2 pbw), and IOTG chain-transfer agent (0.1 pbw) in an amber glass jar and swirling by hand to mix. The solution was divided into 25 grams aliquots within heat-sealed compartments of an ethylene vinyl acetate-based film, immersed in a 16° C. water bath, and polymerized using UV light (UVA=4.5 J/cm² irradiance). The packaged copolymer was then masticated using an ATR Plasti-corder (C.W. Brabender, Hackensack, N.J.)) equipped with an electrically heated three-part mixer with a capacity of approximately 70 cm³ and high shear counter-rotating blades. The mixer was preheated to 120° C. and approximately 50 grams of copolymer were masticated at mixing speed of 100 rpm for 10 minutes.

### Preparative Oxamide (Ox-1)

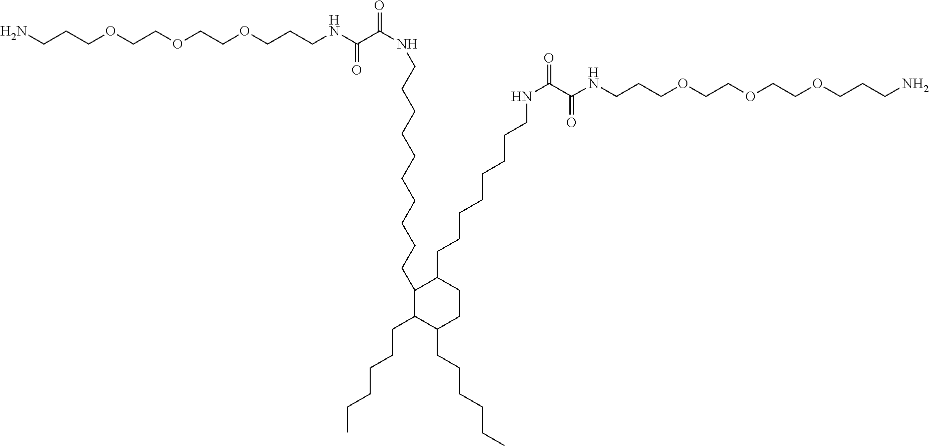 [SMILES: CCCCCCC1CCC(CCCCCCCCNC(=O)C(=O)NCCCOCCOCCOCCCN)C(CCCCCCCCCCNC(=O)C(=O)NCCCOCCOCCOCCCN)C1CCCCCC]

To a 250 mL 2-necked round bottomed flask was added 1075 (54.01 g, 100.1 mmol) and DEOX (29.55 g, 202.2 mmol). The flask was fitted with an overhead stirring apparatus and a nitrogen gas inlet. Under constant nitrogen purge, the reaction was stirred and placed in an oil bath set to 100° C. to react. After 40 minutes at 100° C., TTD (44.53 g, 202.1 mmol) was added to the reaction via syringe. The reaction was continued 90° C. for 18 hours. The reaction was removed from the oil bath and the reaction mixture was poured into a polypropylene jar while still hot. Once cooled the product was a colorless waxy solid. An aliquot of the reaction product was analyzed by 1H and 13C NMR. Spectra indicate complete consumption of the diethyl oxalate and the formation of amide bonds with the desired stoichiometry.

### Core Compounding

Core compositions EP-1 to EP-3 and AM-1 were prepared as follows. Individual components according to Table 1 below were massed into a polypropylene MAX 100 DAC cup (FlackTek, Inc., Landrum, S.C.). The cups were loosely closed with a polypropylene lid and warmed to 100° C. to melt all components. After 30 minutes at temperature each mixture was high-shear mixed at ambient temperature and pressure using a FlakTek, Inc Speed Mixer (DAC 400 FVZ) for 1 minute at 2500 rpm (revolutions per minute).

TABLE 2
Masses used for core compositions EP-1 through EP-3 and AM- and AM-2.

| | | EP-1 | EP-2 | EP-3 | AM-1 | AM-2 |
|---|---|---|---|---|---|---|
| Material | Equiv. wt. | Mass (g) | Mass (g) | Mass (g) | Mass (g) | Mass (g) |
| PA-1 | — | 30.13 | | | | |
| E828 | 189.00 | 69.02 | 35.00 | 35.00 | | |
| E-1001F | 550.00 | 29.05 | 15.00 | 15.00 | | |
| GPTMS | 236.34 | 2.00 | | | | |
| Ox-1 | 271.00 | | | | 45.02 | |
| HC1101 | 5243 | | | | 5.01 | |
| TTD | 55.07 | | | | | 22.03 |
| 2337s | 107.90 | | 3.60 | | | |
| 1075 | 135 | | | | | 27.00 |

TABLE 3
Rheological Data summary for EP-1 through EP-3
and AM-1 and AM-2 at 1 Hz test frequency.

| | Shear Storage Modulus (G′) | Complex Viscosity (η*) |
|---|---|---|
| Material | Pa | Pa · s |
| EP-1 | 11978 | 3390 |
| EP-2 | 10454 | 19658 |
| EP-3 | 1299 | 101 |
| AM-1 | 1218520 | 196096 |
| AM-2* | 0.00386 | 0.0467 |

*Rheological measurement was done with a 40 mm cone fixture with a 2° cone angel and a 53 micrometer cone truncation.

### Sheath Preparation

### Preparation of Sheath 1 (S1)

Films of non-tacky S1 were prepared by hot melt pressing pellets of EMA to average thickness of 5-7 mils (0.127-0.178 mm) in a Model 4389 hot press (Carver, Inc., Wabash, Ind.) at 140° C. Rectangles of film 1.5 inch (3.77 cm) in width and 2.7-5.9 inch (7-15 cm) in length were cut and used in the examples as described below.

### Preparation of Sheath 2 (S2)

In a 500 mL brown glass jar with a screw cap PVOH (45.00 g), glycerol (15.00 g) and water (400.00 g) were combined and heated at 85° C. until a homogeneous solution was obtained. The resulting solution was cast onto a silicone sheet using a steel rod and 1.00 mm steel shims to give a wet coating approximately of 254 mm by 228 by 1 mm. The coated polymer was dried at ambient temperature for 18 hours followed by an additional 24 hours at 100° C. in an oven under dry nitrogen purge. The resulting dry flexible film was 0.13±0.03 mm in thickness. Rectangles of film 1.5 inch (3.77 cm) in width and 2.7-5.9 inch (7-15 cm) in length were cut and used in the examples as described below.

### EXAMPLES

### Preparation of Core/Sheath Curable Adhesive 1 (EX-1)

A core/sheath filament was made by hand rolling 25.00 grams EP-1 into a cylinder 12.5 mm in diameter and surrounding the cylinder with enough S2 rectangles to coat the surface. A second core/sheath filament was made by hand rolling 25.00 g AM-1 into a cylinder 12.5 mm in diameter and surrounding the cylinder with enough S2 rectangles to coat the surface. The two core/sheath filaments were simultaneously added to an ATR Plasti-corder (C.W. Brabender, Hackensack, N.J.)) equipped with an electrically heated three-part mixer with a capacity of approximately 70 cm³ and high shear counter-rotating blades. The mixer was preheated to 65° C. and set at a mixing speed of 100 rpm. The curable adhesive mixture was compound for two minutes before mixing was stopped and samples of the adhesive mixture were taken for Dynamic Shear Test Specimen Preparation as described above.

### Preparation of Core/Sheath Curable Adhesive 2 (EX-2)

A core/sheath filament was made by hand rolling 25.00 grams EP-2 into a cylinder 12.5 mm in diameter and surrounding the cylinder with enough S1 rectangles to coat the surface. A second core/sheath filament was made by hand rolling 25.00 grams AM-1 into a cylinder 12.5 mm in diameter and surrounding the cylinder with enough S1 rectangles to coat the surface. The two core/sheath filaments were simultaneously added to an ATR Plasti-corder (C.W. Brabender, Hackensack, N.J.)) equipped with an electrically heated three-part mixer with a capacity of approximately 70 cm³ and high shear counter-rotating blades. The mixer was preheated to 65° C. and set at a mixing speed of 100 rpm. The curable adhesive mixture was compound for two minutes before mixing was stopped and samples of the adhesive mixture were taken for Dynamic Shear Test Specimen Preparation as described above.

### Preparation of Core/Sheath Curable Adhesive 3 (EX-3)

A core/sheath filament was made by hand rolling 25.00 grams EP-3 into a cylinder 12.5 mm in diameter and surrounding the cylinder with enough S1 rectangles to coat the surface. A second core/sheath filament was made by hand rolling 25.00 grams AM-1 into a cylinder 12.5 mm in diameter and surrounding the cylinder with enough S1 rectangles to coat the surface. The two core/sheath filaments were simultaneously added to an ATR Plasti-corder (C.W. Brabender, Hackensack, N.J.)) equipped with an electrically heated three-part mixer with a capacity of approximately 70 cm³ and high shear counter-rotating blades. The mixer was preheated to 65° C. and set at a mixing speed of 100 rpm. The curable adhesive mixture was compound for two minutes before mixing was stopped and samples of the adhesive mixture were taken for Dynamic Shear Test Specimen Preparation as described above.

Preparation of Composite Filament with Curable Adhesive 4 (EX-4)

A composite filament was made by lining two semi-circular polypropylene molds, 20.0 mm in diameter and 204 mm in length, with S1. 27.05 grams EP-1 was heated to 100° C. and deposited into one of the semi-circular molds. Additional S1 rectangles were used to cover the EP-1 in the first mold. 26.98 grams AM-1 was heated to 100° C. and deposited into the second semi-circular mold and while AM-1 was still warm the two semi-circular molds containing EP-1 and AM-1 were mated together to form a composite filament. After cooling to 23° C., Excess S1 was trimmed away from the seams in the mold with a hot knife and the filament was removed from the mold. The result was a composite filament as depicted in FIG. 4 with a circular cross-section 20.0 mm in diameter and 204 mm in length.

### Comparative Example A (CEA)

A liquid structural adhesive was made by mixing 20.00 grams E828 and 8.66 grams AM-2 in a polypropylene MAX 100 DAC cup (FlackTek, Inc., Landrum, S.C.). The cups were loosely closed with a polypropylene lid and high-shear mixed at ambient temperature and pressure using a FlakTek, Inc Speed Mixer (DAC 400 FVZ) for 1 minute at 2500 rpm (revolutions per minute). Bonds were prepared as described in the Dynamic Shear Test Specimen Preparation method above and were cured at 90° C. for 1 hour.

TABLE 4
Dynamic Shear Test Results

| | Uncured | | Cured 90° C. 1 hour | |
|---|---|---|---|---|
| | Average Peak | Standard | Average Peak | Standard |
| | Stress | Deviation | Stress | Deviation |
| | psi (MPa) | psi (MPa) | psi (MPa) | psi (MPa) |
| EX-1 | 3.014 (0.021) | 0.249 (0.003) | 2634 (18.17) | 180.3 (1.24) |
| EX-2 | 11.60 (0.080) | 1.729 (0.012) | 1581 (10.90) | 121.5 (0.84) |
| EX-3 | — | — | 1643 (11.33) | 94.34 (0.65) |
| CE-A | NA* | NA* | 948.3 (6.53) | 188.4 (1.30) |

*Uncured bonds were not self-supporting, and values could not be measured by the test method.

TABLE 5
Melt flow index values for sheath materials

| | | | Avg. Tensile | |
|---|---|---|---|---|
| | | MFI | Elongation** | |
| Sheath | MFI Method | (grams/10 min) | (%) | Self-Adhesion |
| S1 (EMA) | Literature | 2.0 | >458% | PASS |
| S2 | Not Tested | NA | >348% | PASS |

**Maximum percent elongation was measured tor each tensile test using digital image correlation. The specimens were still intact at the reported values, but the tracking features became sufficiently distorted such that the digital image correlation algorithm could not track the features anymore.

1. A filament article comprising:
a) a curable composition comprising
1) a first part comprising an epoxy resin; and
2) a second part comprising a polyamine having at least two primary or secondary amino groups, wherein the second part is separated from the first part; and
b) a sheath surrounding the first part and the second part, wherein the sheath comprises a thermoplastic material that is non-tacky and wherein either
1) the first part surrounded by the sheath and the second part surrounded by the sheath are each a separate filament; or
2) the first part surrounded by the sheath and the second part surrounded by the sheath combine to form a composite filament.

2. The filament article of claim 1, wherein the first part surrounded by the sheath and the second part surrounded by the sheath are each a separate filament.

3. The filament article of claim 1, wherein the first part surrounded by the sheath and the second part surrounded by the sheath combine to form a composite filament.

4. The filament article of claim 1, wherein the filament article comprises 0.1 to 25 weight percent sheath based on a total weight of the filament article minus any optional filler.

5. The filament article of claim 1, wherein the first part and the second part are semi-solids.

6. The filament article of claim 1, wherein the first part and/or the second part further comprises a film-forming resin.

7. The filament article of claim 1, wherein the polyamine comprises an amine-terminated oxamide and/or a polyether diamine.

8. The filament article of claim 1, wherein a ratio of equivalents of epoxy groups in the first part to equivalents of active hydrogen atoms of the polyamine in the second part is in a range of 0.8 to 1.2.

9. A method of making a filament article comprising a curable composition, the method comprising:
forming (or providing) a first part comprising an epoxy resin; and
forming (or providing) a second part comprising a polyamine having at least two primary or secondary amino group, wherein the second part is separated from the first part;
surrounding each of the first part and the second part with a sheath that includes a thermoplastic resin that is non-tacky, wherein either
1) the first part surrounded by the sheath and the second part surrounded by the sheath are each a separate filament; or
2) the first part surrounded by the sheath and the second part surrounded by the sheath combine to form a composite filament.

10. A method of printing and bonding, the method comprising:
providing a filament article according to claim 1;
melting and blending the filament article to form a molten composition;
dispensing the molten composition through a nozzle onto at least a first portion of a first substrate; and
positioning either a second substrate or a second portion of the first substrate in contact with the molten composition; and
forming a structural adhesive bond between at least the first portion of the first substrate and either the second substrate or the second portion of the first substrate.
